(19) United States
(12) Patent Application Publication
(10) Pub. No.: US 2026/0084413 A1
(43) Pub. Date: Mar. 26, 2026

(54) CAPACITIVE LOAD DRIVE CIRCUIT AND LIQUID EJECTION APPARATUS

(71) Applicant: SEIKO EPSON CORPORATION, Tokyo (JP)

(72) Inventor: Yoichiro KONDO, Chino (JP)

(21) Appl. No.: 19/338,022

(22) Filed: Sep. 24, 2025

(30) Foreign Application Priority Data
Sep. 26, 2024 (JP) 2024-167748

(51) Int. Cl. B41J 2/045

(52) U.S. Cl. CPC B41J 2/04541; B41J 2/0455; B41J 2/04581; B41J 2/04588; B41J 2202/08; B41J 2202/13

(57) ABSTRACT

Provided is a capacitive load drive circuit in which an amplification circuit amplifies a base drive signal and outputs a drive signal for driving a capacitive load includes a first transistor and a second transistor, the first transistor has a first surface and a second surface located to face each other, the second transistor has a third surface and a fourth surface located to face each other, a heat dissipation property of a first heat dissipation member is higher than a heat dissipation property of a second heat dissipation member, the first surface and the third surface are thermally coupled to the first heat dissipation member, the second surface and the fourth surface are thermally coupled to a first substrate surface, and a second substrate surface is thermally coupled to the second heat dissipation member.

The present application is based on, and claims priority from JP Application Serial Number 2024-167748, filed Sep. 26, 2024, the disclosure of which is hereby incorporated by reference herein in its entirety.

### BACKGROUND

### 1. Technical Field

The present disclosure relates to a capacitive load drive circuit and a liquid ejection apparatus.

### 2. Related Art

A liquid ejection apparatus including a liquid ejection head that includes a capacitive load and ejects a liquid such as an ink by driving the capacitive load with a drive signal, and a capacitive load drive circuit that supplies the drive signal to the liquid ejection head is known. For example, JP-A-2018-099852 discloses a liquid ejection apparatus including a drive signal generation circuit (a capacitive load drive circuit) including an analog conversion circuit that designates a waveform of a drive signal and a pair of transistors that outputs the drive signal based on an output from the analog conversion circuit.

The drive signal for driving the liquid ejection head is a signal having a large amplitude, and when the drive signal is supplied to the capacitive load, a large current is accompanied so as to stably drive the capacitive load. In some cases, the pair of transistors that output the drive signal or the analog conversion circuit that designates the waveform of the drive signal may become a high temperature due to the current. When the pair of transistors or the analog conversion circuit becomes a high temperature, the operational stability of the capacitive load drive circuit including the pair of transistors or the analog conversion circuit is lowered, and there is a concern that the waveform accuracy of the output drive signal is lowered.

### SUMMARY

According to an aspect of the present disclosure, there is provided a capacitive load drive circuit including: a base drive signal output circuit to which a digital signal is input and which outputs a base drive signal; an amplification circuit that amplifies the base drive signal and outputs a drive signal for driving a capacitive load; a wiring substrate that has a first substrate surface and a second substrate surface located to face each other, and is provided with the base drive signal output circuit and the amplification circuit; a first heat dissipation member and a second heat dissipation member that promote heat dissipation of the amplification circuit, in which the amplification circuit outputs the drive signal by driving of a first transistor and a second transistor, the first transistor has a first surface and a second surface located to face each other, the second transistor has a third surface and a fourth surface located to face each other, a heat dissipation property of the first heat dissipation member is higher than a heat dissipation property of the second heat dissipation member, the first surface and the third surface are thermally coupled to the first heat dissipation member, the second surface and the fourth surface are thermally coupled to the first substrate surface, and the second substrate surface is thermally coupled to the second heat dissipation member.

According to another aspect of the present disclosure, there is provided a liquid ejection apparatus including: an ejection head that ejects a liquid by driving of a capacitive load; and a capacitive load drive circuit that outputs a drive signal for driving the capacitive load, in which the capacitive load drive circuit includes a base drive signal output circuit to which a digital signal is input and which outputs a base drive signal, an amplification circuit that amplifies the base drive signal and outputs the drive signal for driving the capacitive load, a wiring substrate that has a first substrate surface and a second substrate surface located to face each other, and is provided with the base drive signal output circuit and the amplification circuit, and a first heat dissipation member and a second heat dissipation member that promote heat dissipation of the amplification circuit, in which the amplification circuit outputs the drive signal by driving of a first transistor and a second transistor, the first transistor has a first surface and a second surface located to face each other, the second transistor has a third surface and a fourth surface located to face each other, a heat dissipation property of the first heat dissipation member is higher than a heat dissipation property of the second heat dissipation member, the first surface and the third surface are thermally coupled to the first heat dissipation member, the second surface and the fourth surface are thermally coupled to the first substrate surface, and the second substrate surface is thermally coupled to the second heat dissipation member.

### BRIEF DESCRIPTION OF THE DRAWINGS

FIG. 1 is a view illustrating a schematic configuration of a liquid ejection apparatus.

FIG. 2 is a view illustrating an example of a functional configuration of an ejection unit.

FIG. 3 is a view illustrating a schematic structure of one of a plurality of the ejection portions included in an ejection module.

FIG. 4 is a view illustrating an example of signal waveforms of drive signals.

FIG. 5 is a view illustrating a functional configuration of a drive signal selection circuit.

FIG. 6 is a view illustrating an example of decoding contents in a decoder.

FIG. 7 is a view illustrating an example of a configuration of a selection circuit corresponding to one ejection portion.

FIG. 8 is a view illustrating an operation of the drive signal selection circuit.

FIG. 9 is a view illustrating an example of a configuration of a drive circuit.

FIG. 10 is a view illustrating an example of an operation of an amplification control circuit.

FIG. 11 is a view illustrating an example of a structure of a head drive module.

FIG. 12 is a view illustrating an example of a structure of a drive circuit substrate.

FIG. 13 is a view illustrating an example of a structure of a transistor.

FIG. 14 is a view illustrating an example of thermal coupling between a transistor and an integrated circuit, and a heat sink.

FIG. 15 is a diagram illustrating an example of a cross-section of a head drive module according to a modification example.

### DESCRIPTION OF EMBODIMENTS

Hereinafter, appropriate embodiments of the present disclosure will be described with reference to the drawings. The drawings to be used are for convenience of description. Note that the embodiments to be described below do not inappropriately limit the contents of the present disclosure described in the appended claims. In addition, not all of configurations to be described below are necessarily essential components of the present disclosure.

### 1. Configuration of Liquid Ejection Apparatus

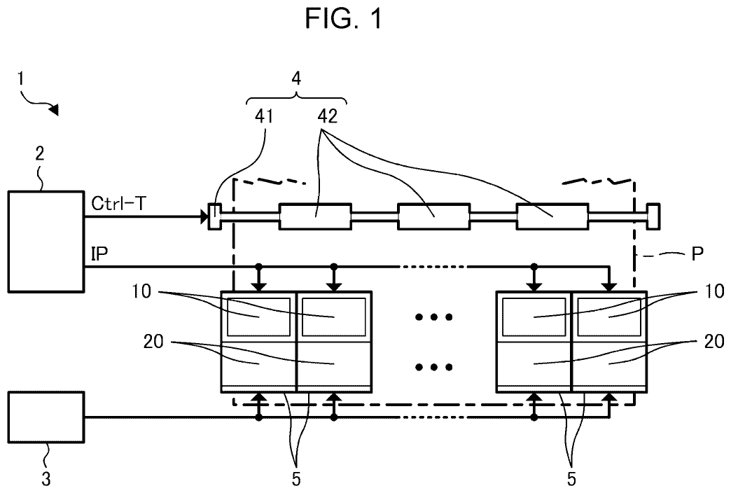

FIG. 1 is a view illustrating a schematic configuration of a liquid ejection apparatus 1. As illustrated in FIG. 1, the liquid ejection apparatus 1 is a so-called line-type ink jet printer that forms a desired image on a medium P transported by a transport unit 4 by ejecting an ink, which is an example of a liquid, onto the medium P at desired timing. Note that the liquid ejection apparatus 1 is not limited to the line-type ink jet printer, and may be a serial-type ink jet printer. In addition, the liquid ejection apparatus 1 is not limited to an ink jet printer, and may be a coloring material ejection apparatus used for manufacturing a color filter such as a liquid crystal display, an electrode material ejection apparatus used for forming an electrode such as an organic EL display and a field emission display (FED), a bioorganic substance ejection apparatus used for manufacturing a biochip, a three-dimensional shaping apparatus, a textile printing apparatus, or the like. Here, in the following description, a direction where the medium P is transported may be referred to as a transport direction, and a width direction of the transported medium P may be referred to as a main scanning direction.

As illustrated in FIG. 1, the liquid ejection apparatus 1 includes a control unit 2, a liquid container 3, the transport unit 4, and a plurality of ejection units 5.

The control unit 2 includes a processing circuit such as a central processing unit (CPU) and a field programmable gate array (FPGA), and a storage circuit such as a semiconductor memory. The control unit 2 outputs a signal for controlling each element of the liquid ejection apparatus 1 based on image data supplied from an external device such as a host computer (not illustrated) provided outside the liquid ejection apparatus 1.

The ink as an example of the liquid supplied to the ejection units 5 is stored in the liquid container 3. Specifically, the liquid container 3 stores a plurality of colors of inks to be ejected to the medium P such as black, cyan, magenta, yellow, red, and gray.

The transport unit 4 includes a transport motor 41 and a transport roller 42. A transport control signal Ctrl-T output by the control unit 2 is input to the transport unit 4. The transport motor 41 operates based on the transport control signal Ctrl-T. The transport roller 42 is rotationally driven in association with an operation of the transport motor 41. As a result, the medium P is transported along the transport direction.

Each of the plurality of ejection units 5 includes a head drive module 10 and a liquid ejection module 20. An image information signal IP output by the control unit 2 is input to the ejection unit 5, and the ink stored in the liquid container 3 is supplied to the ejection unit 5. The head drive module 10 controls an operation of the liquid ejection module 20 based on the input image information signal IP, and the liquid ejection module 20 ejects the ink supplied from the liquid container 3 onto the medium P. At this time, the liquid ejection module 20 included in each of the plurality of ejection units 5 is located in parallel so as to be equal to or larger than the width of the medium P in the main scanning direction, and thus the ink can be ejected to an entire region in the width direction of the transported medium P, and a line-type ink jet printer is configured.

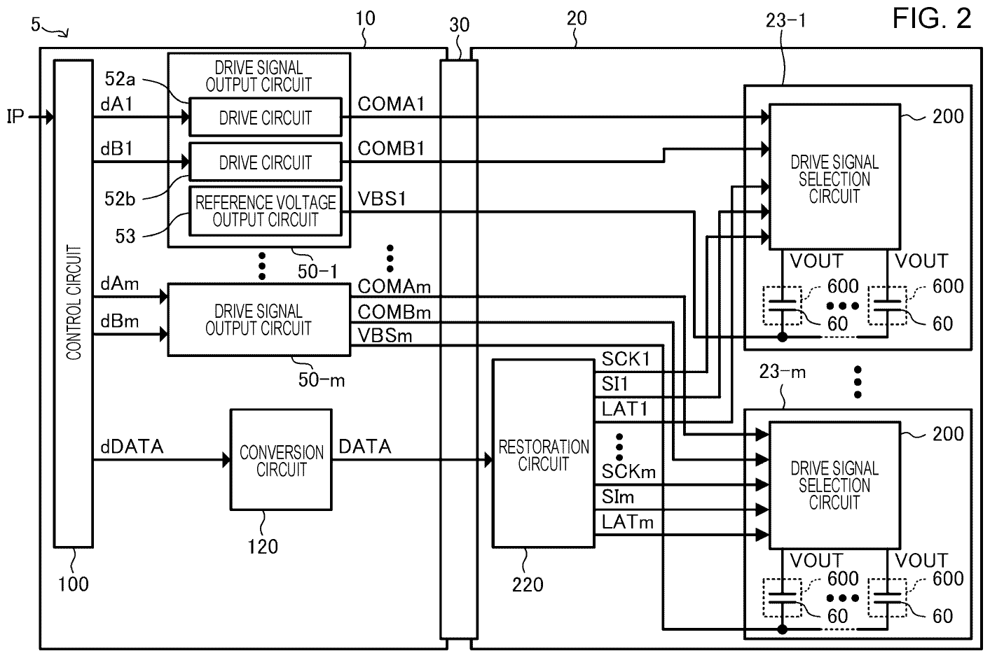

Here, the functional configuration of the ejection unit 5 will be described. FIG. 2 is a view illustrating an example of a functional configuration of the ejection unit 5. As illustrated in FIG. 2, the ejection unit 5 includes the head drive module 10 and the liquid ejection module 20.

The head drive module 10 and the liquid ejection module 20 included in the ejection unit 5 are electrically coupled via a wiring member 30. As the wiring member 30, for example, a flexible printed circuit (FPC) or a flexible flat cable (FFC) can be used. The head drive module 10 and the liquid ejection module 20 may be electrically coupled to each other via a board to board (BtoB) connector instead of or in addition to the FPC or the FFC described above. That is, the wiring member 30 may include a coupling member such as a board to board (BtoB) connector in addition to the FPC and the FFC described above.

The head drive module 10 includes a control circuit 100, drive signal output circuits 50-1 to 50-m, and a conversion circuit 120.

The control circuit 100 includes a CPU, an FPGA, or the like. The image information signal IP output by the control unit 2 is input to the control circuit 100. The control circuit 100 outputs a signal for controlling each element of the ejection unit 5 based on the input image information signal IP.

Specifically, the control circuit 100 generates voltage change amount data dDATA for controlling the operation of the liquid ejection module 20 based on the image information signal IP, and outputs the voltage change amount data dDATA to the conversion circuit 120. The conversion circuit 120 converts the voltage change amount data dDATA into a differential signal such as low voltage differential signaling (LVDS), and outputs the voltage change amount data dDATA to the liquid ejection module 20 as a data signal DATA. The conversion circuit 120 may convert the voltage change amount data dDATA into a differential signal of a high-speed transfer method other than LVDS, for example, a differential signal of a high-speed transfer method such as low voltage positive emitter coupled logic (LVPECL) or current mode logic (CML), and output the converted differential signal to the liquid ejection module 20 as data signal DATA. In addition, the conversion circuit 120 may output a part or all of the input voltage change amount data dDATA to the liquid ejection module 20 as single-ended data signal DATA.

In addition, the control circuit 100 outputs digital waveform signals dA1 and dB1 to the drive signal output circuit 50-1. The drive signal output circuit 50-1 includes drive circuits 52a and 52b. The digital waveform signal dA1 is input to the drive circuit 52a. The drive circuit 52a generates a drive signal COMA1 by performing digital/analog conversion on the input digital waveform signal dA1 and then performing class AB amplification, and outputs the drive signal COMA1 to the liquid ejection module 20. The digital waveform signal dB1 is input to the drive circuit 52b. The drive circuit 52b generates a drive signal COMB1 by performing digital/analog conversion on the input digital waveform signal dB1 and then performing class AB amplification, and outputs the drive signal COMB1 to the liquid ejection module 20. That is, the digital waveform signals dA1 and dB1 are digital signals that define the signal waveforms of the drive signals COMA1 and COMB1, and the drive circuits 52a and 52b generate and output the drive signals COMA1 and COMB1 by amplifying the signal waveforms defined by the digital waveform signals dA1 and dB1.

In addition, the drive signal output circuit 50-1 includes a reference voltage output circuit 53. The reference voltage output circuit 53 generates a reference voltage signal VBS1 having a constant potential indicating a reference potential of a piezoelectric element 60, which will be described below, included in the liquid ejection module 20, and outputs the reference voltage signal VBS1 to the liquid ejection module 20. The reference voltage signal VBS1 may be, for example, a ground potential or a constant potential such as 5.5 V or 6 V. Note that the constant potential includes a case where it can be regarded as a substantially constant potential when an error such as a fluctuation of the potential caused by an operation of the peripheral circuit, a fluctuation of the potential caused by a variation in the circuit element, and a fluctuation of the potential caused by temperature characteristics of the circuit element is taken into consideration.

The drive signal output circuits 50-2 to 50-m have the same configuration as the drive signal output circuit 50-1 except that the input signal and the output signal are different. That is, a drive signal output circuit 50-j (j is any one of 1 to m) includes circuits corresponding to the drive circuits 52a and 52b and a circuit corresponding to the reference voltage output circuit 53. Then, the circuits corresponding to the drive circuits 52a and 52b generate drive signals COMAj and COMBj based on digital waveform signals dAj and dBj input from the control circuit 100, and output the drive signals COMAj and COMBj to the liquid ejection module 20, and the circuit corresponding to the reference voltage output circuit 53 generates a reference voltage signal VBSj and outputs the reference voltage signal VBSj to the liquid ejection module 20.

The liquid ejection module 20 includes a restoration circuit 220 and ejection modules 23-1 to 23-m.

The data signal DATA output by the conversion circuit 120 is input to the restoration circuit 220. The restoration circuit 220 restores the input data signal DATA to a single-ended signal, separates the data signal DATA into signals corresponding to the ejection modules 23-1 to 23-m, and outputs the separated signals to the corresponding ejection modules 23-1 to 23-m.

Specifically, the restoration circuit 220 restores and separates the data signal DATA to generate a clock signal SCK1, a print data signal SI1, and a latch signal LAT1 corresponding to the ejection module 23-1, and outputs these signals to the ejection module 23-1. In addition, the restoration circuit 220 restores and separates the data signal DATA to generate a clock signal SCKj, a print data signal SIj, and a latch signal LATj corresponding to an ejection module 23-j, and outputs these signals to an ejection module 23-j.

That is, the restoration circuit 220 restores the data signal DATA as the differential signal output by the head drive module 10, and separates the restored signal into signals corresponding to the ejection modules 23-1 to 23-m. As a result, the restoration circuit 220 generates clock signals SCK1 to SCKm, print data signals SI1 to SIm, and latch signals LAT1 to LATm corresponding to the ejection modules 23-1 to 23-m, and outputs these signals to the corresponding ejection modules 23-1 to 23-m. Any one of the clock signals SCK1 to SCKm, the print data signals SI1 to SIm, and the latch signals LAT1 to LATm corresponding to the ejection modules 23-1 to 23-m, which are output by the restoration circuit 220, may be common signals for the ejection modules 23-1 to 23-m.

Here, in view of the fact that the restoration circuit 220 generates the clock signals SCK1 to SCKm, the print data signals SI1 to SIm, and the latch signals LAT1 to LATm by restoring and separating the data signal DATA, the data signal DATA output by the control circuit 100 is a differential signal corresponding to the clock signals SCK1 to SCKm, the print data signals SI1 to SIm, and the latch signals LAT1 to LATm, and the voltage change amount data dDATA on which the data signal DATA is based includes signals corresponding to the clock signals SCK1 to SCKm, the print data signals SI1 to SIm, and the latch signals LAT1 to LATm. That is, the voltage change amount data dDATA includes a signal for controlling the operation of the ejection modules 23-1 to 23-m included in the liquid ejection module 20. The ejection unit 5 may not include the conversion circuit 120 and the restoration circuit 220, and may have a configuration in which the control circuit 100 outputs each of the clock signals SCK1 to SCKm, the print data signals SI1 to SIm, and the latch signals LAT1 to LATm.

The ejection module 23-1 includes a drive signal selection circuit 200 and a plurality of ejection portions 600. In addition, each of the plurality of ejection portions 600 includes a piezoelectric element 60.

The drive signals COMA1 and COMB1 and the reference voltage signal VBS1 output by the drive signal output circuit 50-1, and the clock signal SCK1, the print data signal SI1, and the latch signal LAT1 output by the restoration circuit 220 are input to the ejection module 23-1. The drive signals COMA1 and COMB1, the clock signal SCK1, the print data signal SI1, and the latch signal LAT1 are input to the drive signal selection circuit 200 included in the ejection module 23-1. The drive signal selection circuit 200 generates the drive signal VOUT by selecting or not selecting the signal waveforms included in each of the drive signals COMA1 and COMB1 based on the input clock signal SCK1, print data signal SI1, and latch signal LAT1, and supplies the drive signal VOUT to one end of the piezoelectric element 60 included in the corresponding ejection portion 600. At this time, the reference voltage signal VBS1 is supplied to the other end of the piezoelectric element 60. The piezoelectric element 60 is driven by a potential difference between the drive signal VOUT supplied to the one end and the reference voltage signal VBS1 supplied to the other end, so that an ink is ejected from the corresponding ejection portion 600.

The ejection modules 23-2 to 23-m have the same configuration as in the ejection module 23-1 except that the input signal and the output signal are different. That is, the ejection module 23-j includes the drive signal selection circuit 200 and the plurality of ejection portions 600, and each of the plurality of ejection portions 600 includes the piezoelectric element 60. Drive signals COMAj and COMBj, a reference voltage signal VBSj, a clock signal SCKj, a print data signal SIj, and a latch signal LATj are input to the ejection module 23-j. The drive signal selection circuit 200 generates the drive signal VOUT by selecting or not selecting a signal waveform included in each of the drive signals COMAj and COMBj based on the input clock signal SCKj, print data signal SIj, and latch signal LATj, and supplies the drive signal VOUT to one end of the piezoelectric element 60 included in the corresponding ejection portion 600. At this time, a reference voltage signal VBSj is supplied to the other end of the piezoelectric element 60. The piezoelectric element 60 is driven by a potential difference between the drive signal VOUT supplied to the one end and the reference voltage signal VBSj supplied to the other end, so that an ink is ejected from the corresponding ejection portion 600.

As described above, in the liquid ejection apparatus 1 of the present embodiment, the control unit 2 controls the transport of the medium P by the transport unit 4 and controls ejection of the ink from the liquid ejection module 20 of the ejection unit 5 based on the image data supplied from a host computer (not illustrated) or the like, and thus lands a desired amount of ink at a desired position on the medium P to form a desired image on the medium P. That is, the liquid ejection apparatus 1 includes the liquid ejection module 20 including the ejection modules 23-1 to 23-m that eject ink by driving of the piezoelectric element 60, and the head drive module 10 including the drive signal output circuits 50-1 to 50-m that output the drive signals COMA1 to COMAm and COMB1 to COMBm for driving the piezoelectric element 60.

Here, the drive signal output circuits 50-1 to 50-m have the same configuration, and when it is not necessary to distinguish them, the drive signal output circuits 50-1 to 50-m may be simply referred to as a drive signal output circuit 50 in the following description. In addition, when it is not necessary to distinguish the drive circuits 52a and 52b included in each of the drive signal output circuits 50-1 to 50-m, the drive circuits 52a and 52b may be simply referred to as a drive circuit 52 in the following description. In this case, as the digital waveform signals dA1 to dAm and dB1 to dBm, a digital waveform signal dO is input to the drive circuit 52, and the drive circuit 52 generates and outputs the drive signal COM as the drive signals COMA1 to COMAm and COMB1 to COMBm based on the input digital waveform signal do. On the other hand, when the drive circuits 52a and 52b included in each of the drive signal output circuits 50-1 to 50-m are described in a distinguished manner, in the following description, the drive circuits 52a and 52b included in the drive signal output circuit 50-j may be referred to as drive circuits 52aj and 52bj.

In addition, the reference voltage output circuits 53 included in drive signal output circuits 50-1 to 50-m have the same configuration, and when it is not necessary to distinguish the drive signal output circuits 50-1 to 50-m, in the following description, the reference voltage output circuits 53 may be simply referred to as a reference voltage output circuit 53. In this case, the reference voltage output circuit 53 will be described as generating and outputting the reference voltage signal VBS as the reference voltage signals VBS1 to VBSm. On the other hand, when the reference voltage output circuit 53 included in each of the drive signal output circuits 50-1 to 50-m is described in a distinguished manner, in the following description, the reference voltage output circuit 53 included in the drive signal output circuit 50-j may be referred to as a reference voltage output circuit 53-j.

In addition, the ejection modules 23-1 to 23-m have the same configuration, and when it is not necessary to distinguish the ejection modules 23-1 to 23-m, the ejection modules 23-1 to 23-m may be simply referred to as an ejection module 23 in the following description. In this case, it is described that the SCK as the clock signals SCK1 to SCKm, the print data signal SI as the print data signals SI1 to SIm, the latch signal LAT as the latch signals LAT1 to LATm, the drive signal COMA as the drive signals COMA1 to COMAm, the drive signal COMB as the drive signals COMB1 to COMBm, and the reference voltage signal VBS as the reference voltage signals VBS1 to VBSm are input to the ejection module 23.

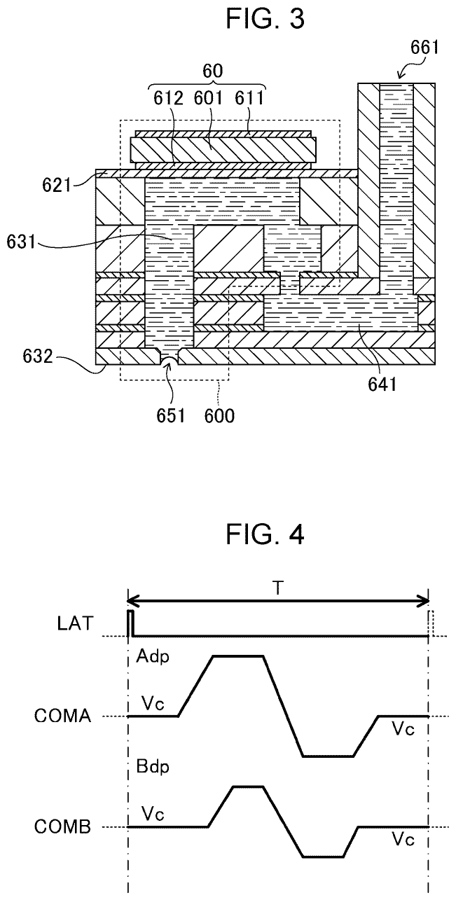

Here, an example of the structure of the ejection portion 600 included in the ejection module 23 will be described. FIG. 3 is a view illustrating a schematic structure of one of the plurality of ejection portions 600 included in the ejection module 23. As illustrated in FIG. 3, the ejection portion 600 includes the piezoelectric element 60, a vibrating plate 621, a cavity 631, and a nozzle 651.

The cavity 631 is filled with an ink supplied from a reservoir 641. The ink is introduced into the reservoir 641 from the liquid container 3 via an ink tube (not illustrated) and a supply port 661. In other words, the cavity 631 is filled with the ink stored in the corresponding liquid container 3.

The vibrating plate 621 is displaced by driving of the piezoelectric element 60 provided on an upper surface in FIG. 3. As the vibrating plate 621 is displaced, an internal volume of the cavity 631 filled with ink is expanded or reduced. That is, the vibrating plate 621 functions as a diaphragm that changes the internal volume of the cavity 631.

The nozzle 651 is an opening provided in a nozzle plate 632 and communicating with the cavity 631. Then, as the internal volume of the cavity 631 changes, the ink having an amount depending on the change in internal volume is ejected from the nozzle 651.

The piezoelectric element 60 has a structure in which a piezoelectric body 601 is interposed between a pair of electrodes 611 and 612. In the piezoelectric body 601 having such a structure, central portions of the electrodes 611 and 612 bend in a vertical direction in combination with the vibrating plate 621 in correspondence with a potential difference of signals supplied to the electrodes 611 and 612. The ink in an amount corresponding to deformation of the piezoelectric element 60 and the vibrating plate 621 is ejected.

Specifically, the drive signal VOUT is supplied to one of the electrodes 611 or 612 which is one end of the piezoelectric element 60, and the reference voltage signal VBS is supplied to the other of the electrodes 611 or 612 which is the other end of the piezoelectric element 60. When a voltage value of the drive signal VOUT increases, the piezoelectric element 60 bends in an upward direction. When the piezoelectric element 60 bends in the upward direction, the vibrating plate 621 is displaced, and an internal volume of the cavity 631 is expanded. As a result, the ink is drawn from the reservoir 641. On the other hand, when the voltage value of the drive signal VOUT decreases, the piezoelectric element 60 bends in a downward direction. When the piezoelectric element 60 bends in the downward direction, the vibrating plate 621 is displaced and the internal volume of the cavity 631 is reduced. As a result, the ink having an amount corresponding to the degree of reduction is ejected from the nozzle 651. That is, the ejection portion 600 includes the piezoelectric element 60 driven by the drive signal VOUT based on the drive signal COM, and ejects the ink by driving of the piezoelectric element 60.

The structure of the piezoelectric element 60 may be any structure as long as the ink can be ejected from the ejection portion 600 by driving, and is not limited to the structure of bending vibration as illustrated in FIG. 3, and may be, for example, a structure using longitudinal vibration. In addition, the piezoelectric element 60 may be configured to bend in the downward direction as the voltage value of the drive signal VOUT increases and bend in the upward direction as the voltage value of the drive signal VOUT decreases.

### 2. Functional Configuration of Drive Signal Selection Circuit

Next, a configuration and an operation of the drive signal selection circuit 200 included in the ejection module 23 will be described. In describing the configuration and the operation of the drive signal selection circuit 200 included in the ejection module 23, first, an example of signal waveforms included in the drive signals COMA and COMB input to the drive signal selection circuit 200 will be described.

FIG. 4 is a view illustrating an example of the signal waveforms of the drive signals COMA and COMB. As illustrated in FIG. 4, the drive signal COMA includes a drive waveform Adp arranged in a period T from rise of the latch signal LAT to the next rise of the latch signal LAT. The drive waveform Adp is a signal waveform that is supplied to one end of the piezoelectric element 60 to eject a predetermined amount of ink from the ejection portion 600 corresponding to the piezoelectric element 60. The drive signal COMB includes a drive waveform Bdp arranged in the period T. The drive waveform Bdp is a signal waveform having a voltage amplitude smaller than that of the drive waveform Adp, and is a signal waveform for ejecting a small amount of ink as compared with the predetermined amount from the ejection portion 600 corresponding to the piezoelectric element 60 by being supplied to one end of the piezoelectric element 60. Voltage values of the drive waveforms Adp and Bdp at start timing and termination timing of each of the drive waveforms Adp and Bdp are common to each other and are a voltage Vc. That is, each of the drive waveforms Adp and Bdp is a signal waveform that starts at the voltage Vc and ends at the voltage Vc.

Here, in the following description, when the drive waveform Adp is supplied to one end of the piezoelectric element 60, the amount of the ink ejected from the ejection portion 600 corresponding to the piezoelectric element 60 may be referred to as a large amount, and when the drive waveform Bdp is supplied to one end of the piezoelectric element 60, the amount of the ink ejected from the ejection portion 600 corresponding to the piezoelectric element 60 may be referred to as a small amount.

Note that the signal waveforms included in the drive signals COMA and COMB are not limited to the signal waveforms illustrated in FIG. 4, and various signal waveforms may be used in correspondence with a type of the ink ejected from the ejection portion 600, the number of piezoelectric elements 60 driven by the drive signals COMA and COMB, a wiring length through which the drive signals COMA and COMB propagate, and the like. For example, each of the drive signals COMA1 to COMAm may include a different signal waveform, and each of the drive signals COMB1 to COMBm may include a different signal waveform. In addition, for example, each of the drive signals COMA and COMB may include two or more continuous drive waveforms in the period T. In this case, a signal defining switching timing of two or more drive waveforms is input to the drive signal selection circuit 200, and the ejection portion 600 ejects the ink a plurality of times in the period T. The ink ejected in the plurality of times in the period T lands on the medium P and is combined to form one dot on the medium P. For example, the drive signals COMA and COMB may include so-called micro-vibration waveforms that are signal waveforms for vibrating the ink in the vicinity of the opening of the nozzle 651 in order to reduce the possibility that the viscosity of the ink in the vicinity of the opening of the nozzle 651 increases.

Here, in the following description, the period T from the rise of the latch signal LAT to the next rise of the latch signal LAT may be referred to as a dot formation period for forming dots having a desired size on the medium P.

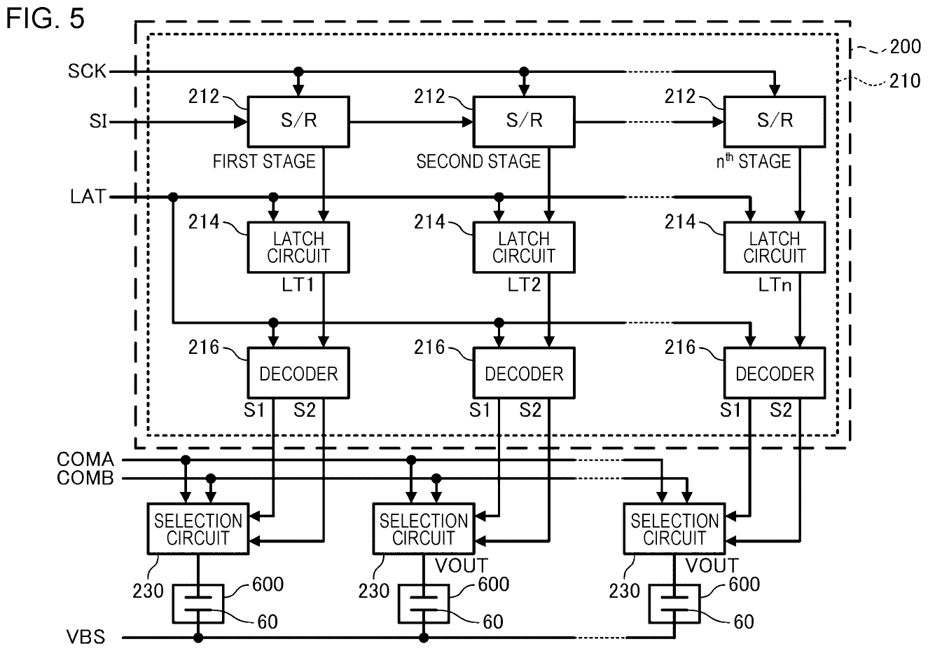

Next, the configuration and operation of the drive signal selection circuit 200 that generates and outputs the drive signal VOUT by selecting or not selecting the signal waveforms included in each of the drive signals COMA and COMB will be described. FIG. 5 is a view illustrating a functional configuration of the drive signal selection circuit 200. As illustrated in FIG. 5, the drive signal selection circuit 200 includes a selection control circuit 210 and a plurality of selection circuits 230. Here, in the following description, it is assumed that the ejection module 23 includes n ejection portions 600 as a plurality of ejection portions 600.

The print data signal SI, the latch signal LAT, and the clock signal SCK are input to the selection control circuit 210. In addition, the selection control circuit 210 includes a set of a shift register (S/R) 212, a latch circuit 214, and a decoder 216 corresponding to each of the n ejection portions 600. That is, the drive signal selection circuit 200 includes n shift registers 212, n latch circuits 214, and n decoders 216, which are the same as the total number of the ejection portions 600.

The print data signal SI is a signal synchronized with the clock signal SCK, and includes 2-bit print data [SIH, SIL] for defining a dot size formed by the ink ejected from each of the n ejection portions 600 as any of “large dot LD”, “small dot SD”, and “non-ejection ND”. This print data signal SI is held in the shift register 212 corresponding to the ejection portion 600 for each 2-bit print data [SIH, SIL].

Specifically, the n shift registers 212 corresponding to the ejection portions 600 are cascade-coupled to each other. The print data signal SI that is serially input is sequentially transferred to a subsequent stage of the shift register 212 cascade-coupled in accordance with the clock signal SCK. When supply of the clock signal SCK is stopped, the n shift registers 212 hold the 2-bit print data [SIH, SIL] corresponding to the ejection portions 600 corresponding to the shift registers 212. In FIG. 5, in order to distinguish the n cascade-coupled shift registers 212, the shift registers 212 are denoted as first stage, second stage, . . . , n^{th} stage from an upstream to a downstream where the print data signal SI is input.

Each of the n latch circuits 214 simultaneously latches the 2-bit print data [SIH, SIL] held by the corresponding shift register 212 at the rise of the latch signal LAT.

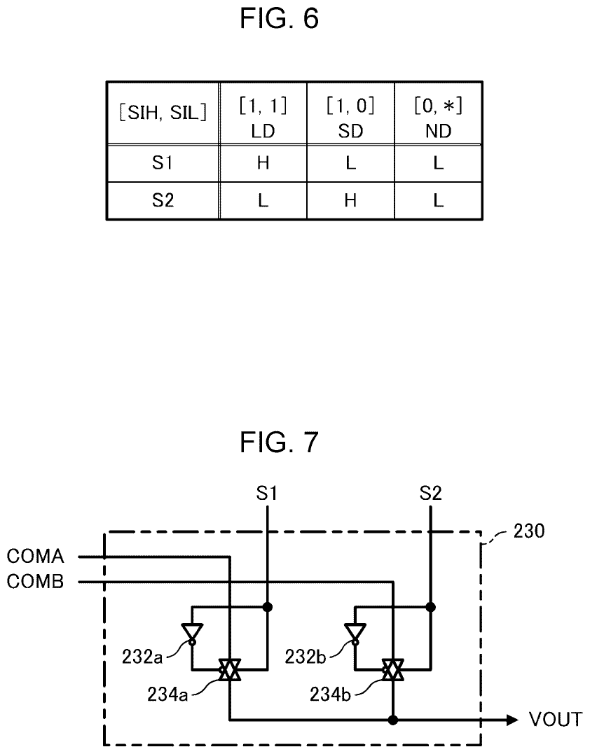

Each of the n decoders 216 decodes the 2-bit print data [SIH, SIL] latched by the corresponding latch circuit 214, and outputs logic level selection signals S1 and S2 corresponding to the decoding content for each period T. FIG. 6 is a view illustrating an example of decoding contents in the decoder 216. The decoder 216 outputs the logic level selection signals S1 and S2 defined by the latched 2-bit print data [SIH, SIL] and the decoding contents illustrated in FIG. 6. For example, when the 2-bit print data [SIH, SIL]=[1, 0] latched by the corresponding latch circuit 214, the decoder 216 sets the logic levels of the selection signals S1 and S2 to the L and H levels, respectively, in the period T. In FIG. 6, the print data [SIH, SIL]=[0, 0] and the print data [SIH, SIL]=[0, 1] are collectively illustrated as the print data [SIH, SIL]=[0, *].

The selection circuit 230 is provided in correspondence with each of the n ejection portions 600. That is, the drive signal selection circuit 200 includes n selection circuits 230. The selection signals S1 and S2 output by the same decoder 216 corresponding to the ejection portion 600 and the drive signals COMA and COMB are input to the selection circuit 230. The selection circuit 230 generates a drive signal VOUT by selecting or not selecting signal waveforms included in the drive signals COMA and COMB in correspondence with the selection signals S1 and S2, and outputs the drive signal VOUT to the corresponding ejection portion 600.

FIG. 7 is a view illustrating an example of a configuration of the selection circuit 230 corresponding to one ejection portion 600. As illustrated in FIG. 7, the selection circuit 230 includes inverters 232a and 232b, and transfer gates 234a and 234b.

The selection signal S1 is input to a positive control terminal not marked with a circle at the transfer gate 234a, is logically inverted by the inverter 232a, and is input to a negative control terminal marked with a circle at the transfer gate 234a. In addition, the drive signal COMA is supplied to an input terminal of the transfer gate 234a. The transfer gate 234a is conductive between the input terminal and an output terminal when the input selection signal S1 is at the H level, and is non-conductive between the input terminal and the output terminal when the input selection signal S1 is at the L level. That is, the transfer gate 234a outputs the drive signal COMA to the output terminal when the selection signal S1 is at the H level, and does not output the drive signal COMA to the output terminal when the selection signal S1 is at the L level.

The selection signal S2 is input to a positive control terminal not marked with a circle at the transfer gate 234b, is logically inverted by the inverter 232b, and is input to a negative control terminal marked with a circle at the transfer gate 234b. In addition, the drive signal COMB is supplied to an input terminal of the transfer gate 234b. The transfer gate 234b is conductive between the input terminal and an output terminal when the input selection signal S2 is at the H level, and is non-conductive between the input terminal and the output terminal when the input selection signal S2 is at the L level. That is, the transfer gate 234b outputs the drive signal COMB to the output terminal when the selection signal S2 is at the H level, and does not output the drive signal COMB to the output terminal when the selection signal S2 is at the L level.

The output terminals of the transfer gates 234a and 234b are commonly coupled. The drive signals COMA and COMB selected or not selected by the selection signals S1 and S2 are supplied to the output terminals of the transfer gates 234a and 234b commonly coupled to each other. The selection circuit 230 outputs the signal supplied to the commonly coupled output terminals to the corresponding ejection portion 600 as the drive signal VOUT.

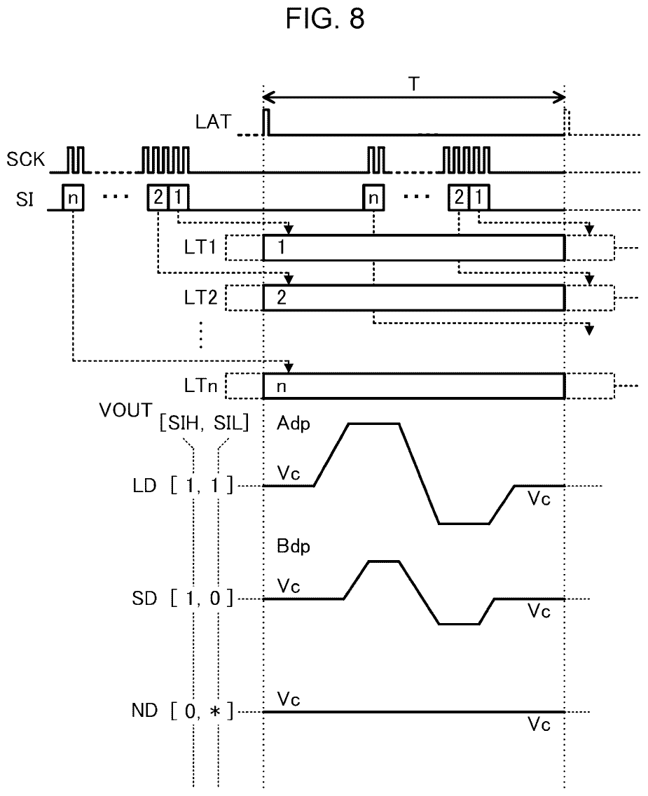

An operation of the drive signal selection circuit 200 will be described. FIG. 8 is a view for describing the operation of the drive signal selection circuit 200. The print data signal SI is serially input in synchronization with the clock signal SCK, and is sequentially transferred by the shift register 212 corresponding to the ejection portion 600. When the input of the clock signal SCK is stopped, the 2-bit print data [SIH, SIL] corresponding to each of the ejection portions 600 is held in the corresponding shift register 212.

Thereafter, when the latch signal LAT rises, the 2-bit print data [SIH, SIL] held in the shift register 212 are simultaneously latched by the latch circuit 214. Note that in FIG. 8, the 2-bit print data [SIH, SIL], which are latched by the latch circuit 214, corresponding to first stage, second stage, . . . , n^{th} stage shift registers 212 are illustrated as LT1, LT2, . . . , LTn.

The decoder 216 outputs the logic level selection signals S1 and S2 corresponding to a dot size defined by the latched 2-bit print data [SIH, SIL].

Specifically, when the print data [SIH, SIL]=[1, 1], the decoder 216 outputs the logic levels of the selection signals S1 and S2 as H and L levels to the selection circuit 230 in the period T. As a result, the selection circuit 230 selects the drive waveform Adp in the period T, and outputs the drive signal VOUT corresponding to the “large dot LD”. In addition, when the print data [SIH, SIL]=[1, 0], the decoder 216 outputs the logic levels of the selection signals S1 and S2 as L and H levels to the selection circuit 230 in the period T. As a result, the selection circuit 230 selects the drive waveform Bdp in the period T, and outputs the drive signal VOUT corresponding to the “small dot SD”. In addition, when the print data [SIH, SIL]=[0, 1] and when the print data [SIH, SIL]=[0, 0], the decoder 216 outputs the logic levels of the selection signals S1 and S2 as L and L levels to the selection circuit 230 in the period T. As a result, the selection circuit 230 does not select any of the drive waveforms Adp and Bdp in the period T, and outputs the drive signal VOUT corresponding to the constant “non-ejection ND” at the voltage Vc.

Here, when the selection circuit 230 does not select any of the drive waveforms Adp and Bdp, the voltage Vc supplied immediately before to the piezoelectric element 60 is held by a capacitive component of the piezoelectric element 60 at one end of the corresponding piezoelectric element 60. That is, the fact that the selection circuit 230 outputs the constant drive signal VOUT at the voltage Vc includes a case where the voltage Vc immediately before being held by the capacitive component of the piezoelectric element 60 is supplied to the piezoelectric element 60 as the drive signal VOUT when any of the drive waveforms Adp and Bdp is not selected as the drive signal VOUT.

As described above, the drive signal selection circuit 200 selects or does not select the drive signals COMA and COMB based on the print data signal SI, the latch signal LAT, and the clock signal SCK, and thus generates the drive signal VOUT corresponding to each of the plurality of ejection portions 600 and outputs the drive signal VOUT to the corresponding ejection portion 600. As a result, the amount of the ink ejected from each of the plurality of ejection portions 600 is individually controlled.

### 3. Configuration of Drive Circuit

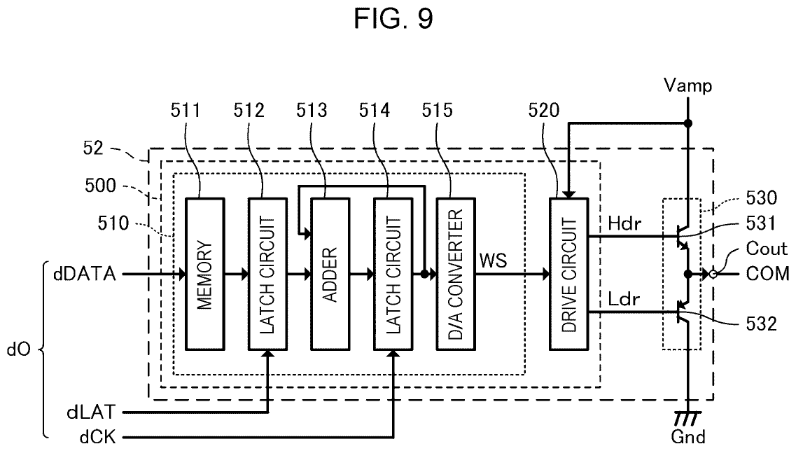

Next, a configuration and an operation of the drive circuit 52 that outputs the drive signals COMA and COMB will be described. FIG. 9 is a view illustrating an example of the configuration of the drive circuit 52. As illustrated in FIG. 9, the drive circuit 52 includes an amplification control circuit 510, a drive circuit 520, and an amplification circuit 530.

The amplification control circuit 510 includes a memory 511, a latch circuit 512, an adder 513, a latch circuit 514, and a D/A converter 515. In addition, voltage change amount data dDATA, latch signal dLAT, and clock signal dCK are input to the amplification control circuit 510 as the digital waveform signal dO output by the control circuit 100.

The voltage change amount data dDATA is input to the memory 511. The memory 511 holds voltage change amount information Dv included in the input voltage change amount data dDATA. The latch signal dLAT is input to the latch circuit 512. The latch circuit 512 latches the voltage change amount information Dv held in the memory 511 at the rise of the input latch signal dLAT. Then, the latch circuit 512 outputs the latched voltage change amount information Dv to the adder 513.

In addition to the voltage change amount information Dv output by the latch circuit 512, a signal output by a latch circuit 514 to be described later is also input to the adder 513. The adder 513 calculates and holds the addition voltage change amount information obtained by adding the voltage change amount information Dv to the signal output by the latch circuit 514.

The clock signal dCK is input to the latch circuit 514. The latch circuit 514 latches the addition voltage change amount information held by the adder 513 at the rise of the clock signal dCK. The latch circuit 514 outputs the latched addition voltage change amount information to the adder 513 and the D/A converter 515. That is, the adder 513 calculates and holds new addition voltage change amount information by adding the voltage change amount information Dv latched by the latch circuit 512 to the addition voltage change amount information latched by the latch circuit 514.

The D/A converter 515 converts the addition voltage change amount information output by the latch circuit 514 into an analog signal, and outputs the analog signal to the drive circuit 520 as a drive waveform signal WS. The drive waveform signal WS output by the D/A converter 515 is a signal waveform in which a voltage value of the drive waveform signal WS output by the amplification control circuit 510 is amplified, and corresponds to a signal waveform of the drive signal COM.

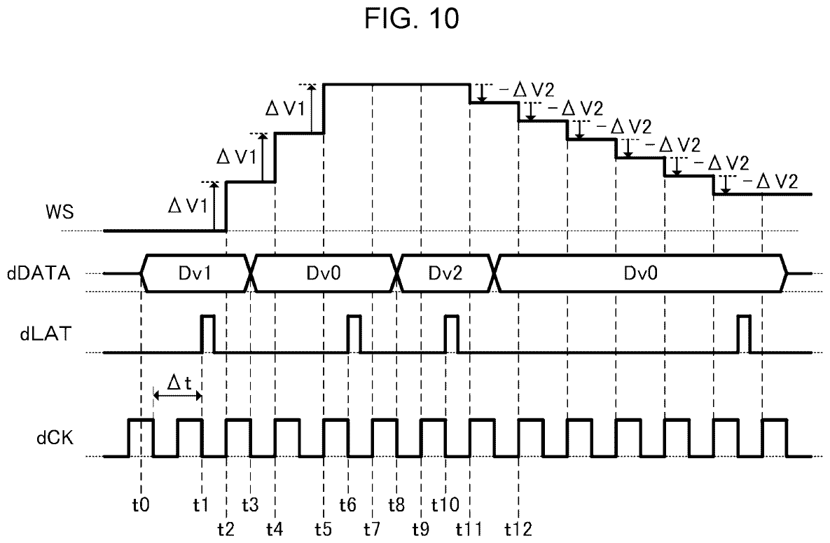

Here, an operation of the amplification control circuit 510 that outputs the drive waveform signal WS will be described. FIG. 10 is a view illustrating an example of the operation of the amplification control circuit 510. As illustrated in FIG. 10, at time to, the control circuit 100 generates the voltage change amount data dDATA including voltage change amount information Dv1 for changing a voltage value to a voltage AV1 as the digital waveform signal do, and outputs the voltage change amount data dDATA to the memory 511. As a result, the voltage change amount information Dv1 is held in the memory 511.

Then, at time t1, the control circuit 100 sets a logic level of the latch signal dLAT as the digital waveform signal dO to a high level. As a result, the voltage change amount information Dv1 held in the memory 511 is latched by the latch circuit 512. At later time t3, the control circuit 100 outputs the voltage change amount data dDATA including voltage change amount information Dv0 for holding a voltage value constant to the memory 511 as the digital waveform signal do. That is, the memory 511 holds the voltage change amount information Dv0 instead of the voltage change amount information Dv1.

The voltage change amount information Dv1 latched by the latch circuit 512 at time t1 is input to the adder 513. The adder 513 adds the voltage change amount information Dv1 latched by the latch circuit 512 to the addition voltage change amount information output by the latch circuit 514, and holds the voltage change amount information Dv1 as new addition voltage change amount information.

In addition, the control circuit 100 generates the clock signal dCK that becomes an H level for each period AT as the digital waveform signal do, and outputs the digital waveform signal dO to the latch circuit 514. Then, at times t2, t4, and t5, when the clock signal dCK at the H level is input to the latch circuit 514, the latch circuit 514 latches the addition voltage change amount information in which a voltage value is increased by the voltage AV1 whenever the clock signal dCK at the H level is input, and outputs the addition voltage change amount information to the D/A converter 515. As a result, the D/A converter 515 generates and outputs the drive waveform signal WS in which the voltage value is increased by the voltage AV1 at time t2, time t4, and time t5.

At later time t6, the control circuit 100 sets a logic level of the latch signal dLAT as the digital waveform signal dO to a high level. As a result, the voltage change amount information Dv0 for holding the voltage value held in the memory 511 to be constant is latched by the latch circuit 512. IN addition, at later time t8, the control circuit 100 generates the voltage change amount data dDATA including the voltage change amount information Dv2 for changing the voltage value to a voltage-AV2 as the digital waveform signal do, and outputs the voltage change amount data dDATA to the memory 511. That is, the memory 511 holds the voltage change amount information Dv2 instead of the voltage change amount information Dv0.

The voltage change amount information Dv0 latched by the latch circuit 512 is input to the adder 513. The adder 513 adds the voltage change amount information Dv0 latched by the latch circuit 512 to the addition voltage change amount information output by the latch circuit 514, and holds the voltage change amount information Dv0 as new addition voltage change amount information.

In addition, at time t7 and time t9, the clock signal dCK at the H level is input to the latch circuit 514. At this time, the voltage change amount information Dv0 latched by the latch circuit 512 is information for holding the voltage value constant. Therefore, the latch circuit 514 latches the addition voltage change amount information in which the voltage value does not change even when the clock signal dCK at the H level is input, and outputs the latched addition voltage change amount information to the D/A converter 515. As a result, the D/A converter 515 generates and outputs the drive waveform signal WS having a constant voltage value at time t7 and time t9.

Then, at time t10, the control circuit 100 sets the logic level of the latch signal dLAT to a high level as the digital waveform signal do. As a result, the voltage change amount information Dv2 for changing the voltage value held in the memory 511 to the voltage-AV2 is latched by the latch circuit 512.

The voltage change amount information Dv2 latched by the latch circuit 512 is input to the adder 513. The adder 513 adds the voltage change amount information Dv2 latched by the latch circuit 512 to the addition voltage change amount information output by the latch circuit 514, and holds the voltage change amount information Dv2 as new addition voltage change amount information.

In addition, the control circuit 100 generates the clock signal dCK that becomes an H level for each period AT as the digital waveform signal do, and outputs the digital waveform signal dO to the latch circuit 514. Then, at time t11 and time t12, when the clock signal dCK at the H level is input to the latch circuit 514, the latch circuit 514 latches the addition voltage change amount information in which the voltage value is decreased by the voltage AV2 whenever the clock signal dCK at the H level is input, and outputs the latched addition voltage change amount information to the D/A converter 515. As a result, the D/A converter 515 generates and outputs the drive waveform signal WS in which the voltage value is decreased by the voltage AV2 at time t11 and time t12.

As described above, the amplification control circuit 510 outputs the drive waveform signal WS having an increased voltage value, the drive waveform signal WS having a decreased voltage value, and the drive waveform signal WS having a constant voltage value based on the digital waveform signal do. That is, the amplification control circuit 510 can output the drive waveform signal WS having a signal waveform corresponding to the digital waveform signal do output by the control circuit 100.

Here, in the liquid ejection apparatus 1 of the present embodiment, description is made on the assumption that the voltage change amount data dDATA included in the digital waveform signal dO input to the amplification control circuit 510 is data indicating the amount of change in the voltage value of the drive waveform signal WS for each period of the clock signal dCK. However, the voltage change amount data dDATA included in the digital waveform signal dO may be data indicating the absolute value of the voltage value of the drive waveform signal WS for each period of the clock signal dCK.

Since the voltage change amount data dDATA included in the digital waveform signal dO is set as data indicating the amount of change in the voltage value of the drive waveform signal WS for each period of the clock signal dCK, the data amount of the voltage change amount data dDATA included in the digital waveform signal dO can be decreased, and as a result, a transmission rate of the voltage change amount data dDATA included in the digital waveform signal do can be increased. On the other hand, when the voltage change amount data dDATA included in the digital waveform signal do is set as data indicating an absolute value of the voltage value of the drive waveform signal WS for each period of the clock signal dCK, the amplification control circuit 510 does not need to include the adder 513 and the latch circuit 514, and as a result, a reduction in size the amplification control circuit 510 can be realized.

Returning to FIG. 9, the drive circuit 520 receives the drive waveform signal WS output by the amplification control circuit 510 and a voltage signal Vamp that has a predetermined voltage value and is input to the amplification circuit 530. Here, the voltage value of the voltage signal Vamp is equal to or greater than a maximum value of the voltage values of the drive waveforms Adp and Bdp included in the drive signals COMA and COMB, and is, for example, a DC voltage of 42 V. The drive circuit 520 generates an amplification drive waveform signal by voltage-amplifying the voltage value of the input drive waveform signal WS based on the voltage signal Vamp. A waveform shape of the amplification drive waveform signal is the waveform shape of the drive waveforms Adp and Bdp included in the drive signals COMA and COMB. The drive circuit 520 generates amplification control signals Hdr and Ldr based on the generated amplification drive waveform signal, and outputs the amplification control signals Hdr and Ldr to the amplification circuit 530.

Specifically, the drive circuit 520 generates the amplification control signal Hdr obtained by adding a bias voltage having a predetermined voltage value to the amplification drive waveform signal and the amplification control signal Ldr obtained by subtracting a bias voltage having a predetermined voltage value from the amplification drive waveform signal, and outputs the signals to the amplification circuit 530. Here, it is preferable that the voltage value of the bias voltage added to the amplification drive waveform signal by the drive circuit 520 is determined in correspondence with a voltage value of a base-emitter saturation voltage of a transistor 531 included in the amplification circuit 530 described later, and the voltage value of the bias voltage subtracted from the amplification drive waveform signal by the drive circuit 520 is determined in correspondence with a voltage value of a base-emitter saturation voltage of a transistor 532 included in the amplification circuit 530 described later. As a result, the possibility that the signal waveform of the drive signal COM output by the drive circuit 52 is distorted is reduced. Such a drive circuit 520 includes, for example, an operational amplifier that voltage-amplifies the voltage value of the drive waveform signal WS based on the voltage signal Vamp. The amplification circuit 530 includes the transistor 531 and the transistor 532. The transistor 531 is an NPN-type bipolar transistor, and the transistor 532 is a PNP-type bipolar transistor. At this time, it is preferable that the transistor 531 and the transistor 532 form a complementary pair.

The voltage signal Vamp is input to a collector terminal of the transistor 531. The amplification control signal Hdr is input to a base terminal of the transistor 531. An emitter terminal of the transistor 531 is electrically coupled to an emitter terminal of the transistor 532. The amplification control signal Ldr is input to a base terminal of the transistor 532. A ground potential Gnd is input to a collector terminal of the transistor 532. The amplification circuit 530 outputs the signal of a coupling point Cout at which the emitter terminal of the transistor 531 and the emitter terminal of the transistor 532 are coupled as the drive signal COM.

In such an amplification circuit 530, when the voltage value of the drive waveform signal WS increases, and when the voltage value of the amplification drive waveform signal generated by the drive circuit 520 increases, conduction between the collector terminal and the emitter terminal of the transistor 531 is controlled, and non-conduction between the emitter terminal and the collector terminal of the transistor 532 is controlled. As a result, a current based on the voltage signal Vamp is supplied to the plurality of piezoelectric elements 60 coupled to the coupling point Cout via the transistor 531. As a result, the voltage value of the drive signal COM output by the amplification circuit 530, which is the voltage value of the coupling point Cout, increases to follow the voltage value of the amplification drive waveform signal generated by the drive circuit 520, due to the capacitive component of the piezoelectric element 60.

In addition, when the voltage value of the drive waveform signal WS decreases and the voltage value of the amplification drive waveform signal generated by the drive circuit 520 decreases, the collector terminal and the emitter terminal of the transistor 531 are controlled to be non-conductive, and the emitter terminal and the collector terminal of the transistor 532 are controlled to be conductive. As a result, electric charges stored in the plurality of piezoelectric elements 60 coupled to the coupling point Cout are discharged to the ground potential Gnd via the transistor 532. As a result, the voltage value of the drive signal COM output by the amplification circuit 530, which is the voltage value of the coupling point Cout, decreases to follow the voltage value of the amplification drive waveform signal generated by the drive circuit 520.

In addition, when the voltage value of the drive waveform signal WS is constant and the voltage value of the amplification drive waveform signal generated by the drive circuit 520 is constant, the collector terminal and the emitter terminal of the transistor 531 are controlled to be non-conductive, and the emitter terminal and the collector terminal of the transistor 532 are controlled to be non-conductive. As a result, the voltage value of the drive signal COM output by the amplification circuit 530, which is the voltage value of the coupling point Cout, is held by the capacitive component of the piezoelectric element 60 coupled to the coupling point Cout. That is, the voltage value of the drive signal COM output by the amplification circuit 530, which is the voltage value of the coupling point Cout, is held at a voltage value equivalent to the voltage value of the amplification drive waveform signal generated by the drive circuit 520.

As described above, in the liquid ejection apparatus 1 of the present embodiment, the drive circuit 52 includes the amplification control circuit 510, the drive circuit 520, and the amplification circuit 530, the amplification control circuit 510 outputs the drive waveform signal WS that defines the signal waveform of the drive signal COM based on the digital waveform signal dO which is the digital signal, and the drive circuit 520 generates the amplification drive waveform signal by voltage-amplifying the drive waveform signal WS. The amplification circuit 530 outputs the amplification drive waveform signal as the drive signal COM by current-amplifying the amplification drive waveform signal. As a result, even when the ejection module 23 includes a large number of piezoelectric elements 60, the drive circuit 52 can output the drive signal COM that can supply an amount of current in a level at which the large number of piezoelectric elements 60 can be stably driven. That is, a drive circuit 52a includes the amplification control circuit 510 to which the digital waveform signal dA1 is input and which outputs the drive waveform signal WS, and the amplification circuit 530 that amplifies the drive waveform signal WS and outputs the drive signal COMA1, and the drive circuit 52b1 includes the amplification control circuit 510 to which the digital waveform signal dB1 is input and which outputs the drive waveform signal WS, and the amplification circuit 530 that amplifies the drive waveform signal WS and outputs the drive signal COMB1. Similarly, each of drive circuits 52a2 to 52am includes the amplification control circuit 510 to which each of the corresponding digital waveform signals dA2 to dAm is input and which outputs the drive waveform signal WS, and the amplification circuit 530 that amplifies the drive waveform signal WS and outputs each of the corresponding drive signals COMA2 to COMAm, and each of drive circuits 52b2 to 52bm includes the amplification control circuit 510 to which each of the corresponding digital waveform signals dB2 to dBm is input and which outputs the drive waveform signal WS, and the amplification circuit 530 that amplifies the drive waveform signal WS and outputs each of the corresponding drive signals COMB2 to COMBm. That is, the head drive module 10 includes a plurality of the amplification control circuits 510 and a plurality of the amplification circuits 530.

At this time, each of the plurality of amplification circuits 530 included in the head drive module 10 includes the transistors 531 and 532 which are bipolar transistors, and outputs the drive signal COM by amplifying the drive waveform signal WS in class AB by driving of the transistors 531 and 532. That is, each of the plurality of amplification circuits 530 included in the liquid ejection apparatus 1 of the present embodiment constitutes a class AB amplification circuit.

Here, in the liquid ejection apparatus 1 of the present embodiment, the drive circuit 520 and the amplification control circuit 510 included in the drive circuit 52 are configured as one integrated circuit 500. As a result, a reduction in size of the drive circuit 52 can be realized. At this time, a part of the circuit that constitutes the amplification control circuit 510 and the drive circuit 520 may be configured outside the integrated circuit 500. In addition, in this case, among the plurality of drive circuits 52 included in the head drive module 10, the amplification control circuit 510 and the drive circuit 520 included in one drive circuit 52 and the amplification control circuit 510 and the drive circuit 520 included in different one drive circuit 52 different from the one drive circuit 52 may be mounted on one integrated circuit 500. That is, the amplification control circuit 510 and the drive circuit 520 included in the drive circuit 52a of the drive signal output circuit 50-j and the amplification control circuit 510 and the drive circuit 520 included in the drive circuit 52b of the drive signal output circuit 50-j may be configured by one integrated circuit 500, and the amplification control circuit 510 and the drive circuit 520 included in the drive circuit 52a of the drive signal output circuit 50-1 and the amplification control circuit 510 and the drive circuit 520 included in the drive circuit 52a of the drive signal output circuit 50-j may be configured by one integrated circuit 500. In the liquid ejection apparatus 1 of the present embodiment, a case where the amplification control circuit 510 and the drive circuit 520 included in the drive circuit 52a of the drive signal output circuit 50-j and the amplification control circuit 510 and the drive circuit 520 included in the drive circuit 52b of the drive signal output circuit 50-j are configured by one integrated circuit 500 will be described as an example.

### 4. Structure of Head Drive Module

When the number of piezoelectric elements 60 driven by the drive signal COM increases, the drive circuit 52 configured as described above increases the amount of current generated by propagation of the drive signal COM, and the amount of heat generated increases. In particular, in the head drive module 10 including the plurality of drive circuits 52 as illustrated in the liquid ejection apparatus 1 of the present embodiment, the plurality of drive circuits 52 are disposed at a high density, and thus the heat generated in the plurality of drive circuits 52 may be concentrated and a local temperature rise may occur. The temperature rise in the head drive module 10 may lower operational stability of the head drive module 10 including the plurality of drive circuits 52, and when the operational stability of the head drive module 10 is lowered, the operational stability of the liquid ejection module 20 whose operation is controlled by the head drive module 10 is also lowered, and as a result, the ejection accuracy of the ink from the liquid ejection module 20 is lowered.

In the liquid ejection apparatus 1 of the present embodiment, with regard to the problem, the head drive module 10 has a unique configuration having excellent heat dissipation performance that can efficiently dissipate the heat generated in the drive circuit 52. As a result, the concern that the operational stability of the head drive module 10 is lowered due to the heat generated in the plurality of drive circuits 52 is reduced. As a result, the possibility that the operational stability of the liquid ejection module 20 is lowered is reduced, and the possibility that the ejection accuracy of the ink from the liquid ejection module 20 is lowered is also reduced.

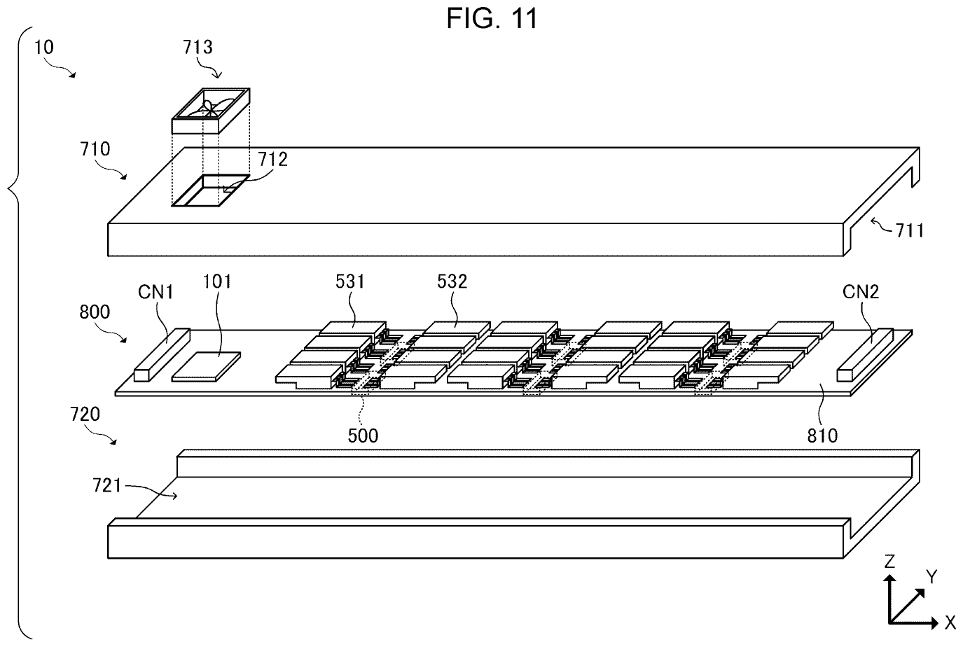

A specific example of the structure of the head drive module 10 having such excellent heat dissipation performance will be described. FIG. 11 is a view illustrating an example of the structure of the head drive module 10. Here, the following description will be made on the assumption that the liquid ejection module 20 includes six ejection modules 23, that is, ejection modules 23-1 to 23-6. Therefore, description will be made on the assumption that the head drive module 10 includes the drive signal output circuits 50-1 to 50-6 corresponding to the ejection modules 23-1 to 23-6, respectively. In addition, in the following description, the description will be made by using an X-axis, a Y-axis, and a Z-axis that are orthogonal to each other. At this time, a starting point side of an arrow along the X-axis illustrated in the drawing may be referred to as a −X side, and a tip end side may be referred to as a +X side. A starting point side of an arrow along the Y-axis illustrated in the drawing may be referred to as a −Y side, and a tip end side may be referred to as a +Y side. A starting point side of an arrow along the Z-axis illustrated in the drawing may be referred to as a −Z side, and a tip end side may be referred to as a +Z side.

As illustrated in FIG. 11, the head drive module 10 includes a drive circuit substrate 800, and heat sinks 710 and 720.

The drive circuit substrate 800 includes a wiring substrate 810 and various circuits including coupling portions CN1 and CN2, an integrated circuit 101, and the drive signal output circuits 50-1 to 50-6 which are mounted on the wiring substrate 810.

The heat sink 710 has a concave portion 711 that is open on the −Z side, and is located on the +Z side of the drive circuit substrate 800, and the heat sink 720 has a concave portion 721 that is open on the −Z side, and is located on the −Z side of the drive circuit substrate 800. The drive circuit substrate 800 is accommodated in a space formed by the concave portion 711 of the heat sink 710 and the concave portion 721 of the heat sink 720. In other words, the drive circuit substrate 800 including the wiring substrate 810 and various circuits including the coupling portions CN1 and CN2, the integrated circuit 101, and the drive signal output circuits 50-1 to 50-6 mounted on the wiring substrate 810 is accommodated in a space formed by the concave portion 711 of the heat sink 710 and the concave portion 721 of the heat sink 720. The drive circuit substrate 800 and the various circuits included in the drive circuit substrate 800 are cooled by both the heat sink 710 and the heat sink 720. In other words, both the heat sink 710 and the heat sink 720 promote cooling of the drive circuit substrate 800 and the various circuits included in the drive circuit substrate 800. Therefore, the heat generated in the drive circuit substrate 800 is efficiently dissipated. As such heat sinks 710 and 720, it is preferable that the heat sinks 710 and 720 are made of a metal material having high thermal conductivity, for example, aluminum, iron, copper, or the like from the viewpoint of efficiently dissipating the heat generated in the drive circuit substrate 800.

In addition, the heat sink 710 has an opening 712 that communicates a surface on the +Z side with the concave portion 711, and a cooling fan 713 attached to the opening 712. The cooling fan 713 sends an airflow to the concave portion 711 provided in the heat sink 710 via the opening 712. As a result, the cooling fan 713 promotes cooling of the drive circuit substrate 800 accommodated in a space formed by the concave portion 711 and the concave portion 721. That is, the heat dissipation property of the heat sink 710 is higher than the heat dissipation property of the heat sink 720 because the heat sink 710 includes the cooling fan 713. Here, the fact that the heat dissipation property of the heat sink 710 is higher than the heat dissipation property of the heat sink 720 is not limited to the configuration using the cooling fan 713, and includes, for example, a case where thermal conductivity of a material used as the heat sink 710 is higher than thermal conductivity of a material used as the heat sink 720, a case where an area contributing to the heat dissipation in the heat sink 710 is larger than an area contributing to the heat dissipation in the heat sink 720, a case where heat capacity contributing to the heat dissipation in the heat sink 710 is larger than heat capacity contributing to the heat dissipation in the heat sink 720, and the like.

As described above, the head drive module 10 includes the heat sink 710 and the heat sink 720 that promote heat dissipation of various circuits provided in the drive circuit substrate 800, that is, the plurality of amplification control circuits 510 and the plurality of amplification circuits 530 included in the drive signal output circuits 50-1 to 50-6 provided in the drive circuit substrate 800.

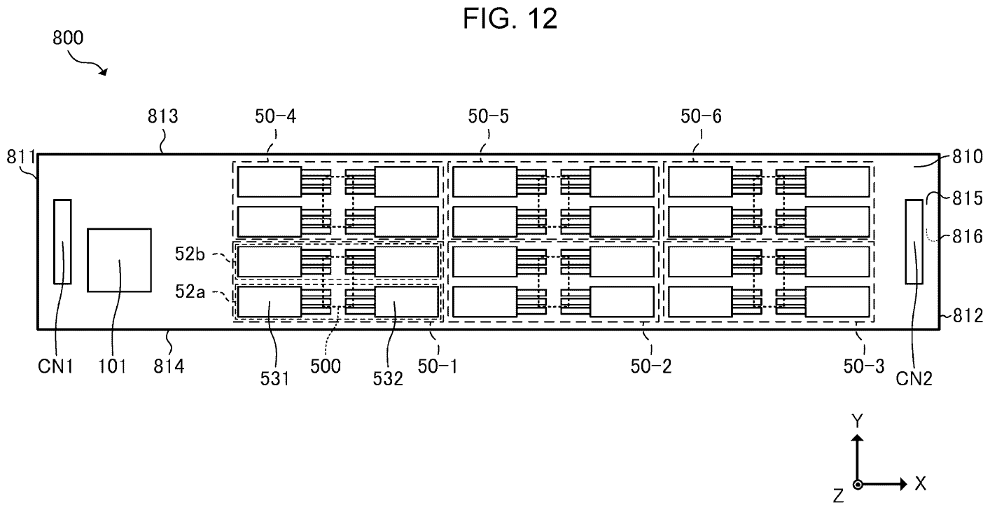

Here, a specific example of the structure of the drive circuit substrate 800 including the wiring substrate 810, the coupling portions CN1 and CN2, the integrated circuit 101, and the drive signal output circuits 50-1 to 50-6 mounted on the wiring substrate 810 will be described. FIG. 12 is a view illustrating an example of the structure of the drive circuit substrate 800. As illustrated in FIG. 12, the drive circuit substrate 800 includes the wiring substrate 810, the drive signal output circuits 50-1 to 50-6, the coupling portions CN1 and CN2, and the integrated circuit 101.

The wiring substrate 810 is a substantially rectangular plate-shaped member including a side 811 that extends along the Y-axis, a side 812 that is located on the +X side of the side 811 and extends along the Y-axis, a side 813 that intersects the sides 811 and 812 and extends along the X-axis, and a side 814 that is located on the −Y side of the side 813, intersects the sides 811 and 812, and extends along the X-axis, and the wiring substrate 810 extends in a plane formed by the X-axis and the Y-axis. The drive signal output circuits 50-1 to 50-6, the coupling portions CN1 and CN2, and the integrated circuit 101 are mounted on the wiring substrate 810. In the following description, in the wiring substrate 810 which is a plate-shaped member extending in the plane formed by the X-axis and the Y-axis, a surface located on the +Z side is referred to as a surface 815, and a surface located on the −Z side is referred to as a surface 816. That is, the head drive module 10 includes the wiring substrate 810 provided with the surface 815 and the surface 816 located to face each other along the Z-axis, the amplification control circuit 510 and the amplification circuit 530 included in the drive circuits 52a and 52b of each of the drive signal output circuits 50-1 to 50-6. The coupling portion CN1 is provided on the surface 815 of the wiring substrate 810 and is located along the side 811. A cable (not illustrated) electrically coupled to the control unit 2 is attached to the coupling portion CN1. As a result, various signals including the image information signal IP output by the control unit 2 are supplied to the head drive module 10 via the coupling portion CN1. The coupling portion CN1 is not limited to a configuration in which a cable through which various signals including the image information signal IP propagate is attached, and may be, for example, a BtoB connector that directly and electrically couples the head drive module 10 and the control unit 2.

The coupling portion CN2 is provided on the surface 815 of the wiring substrate 810 and is located along the side 812. One end of the wiring member 30 is attached to the coupling portion CN2. In addition, the other end of the wiring member 30 is coupled to the liquid ejection module 20. As a result, various signals including the drive signals COMA1 to COMA6 and COMB1 to COMB6 and the data signal DATA output by the head drive module 10 are supplied to the liquid ejection module 20 via the coupling portion CN2.

The integrated circuit 101 is provided on the surface 815 of the wiring substrate 810, and is located on the +X side of the coupling portion CN1 and on the −X side of the coupling portion CN2. A part or the entirety of the above-described control circuit 100 is mounted on the integrated circuit 101. That is, the image information signal IP input via the coupling portion CN1 is input to the integrated circuit 101, and the integrated circuit 101 generates and outputs various signals based on the input image information signal IP. Here, a part or the entirety of the conversion circuit 120 described above may be mounted in the integrated circuit 101 in addition to the control circuit 100. In the liquid ejection apparatus 1 of the present embodiment, description will be made on the assumption that the entirety of the control circuit 100 and the entirety of the conversion circuit 120 are mounted in the integrated circuit 101.

The drive signal output circuits 50-1 to 50-6 are located between the integrated circuit 101 and the coupling portion CN2 in the wiring substrate 810.

Specifically, the drive signal output circuits 50-1 to 50-3 among the drive signal output circuits 50-1 to 50-6 are located in parallel along the X-axis in the order of the drive signal output circuit 50-1, the drive signal output circuit 50-2, and the drive signal output circuit 50-3 from the side 811 toward the side 812 between the integrated circuit 101 and the coupling portion CN2. In addition, the drive signal output circuits 50-4 to 50-6 among the drive signal output circuits 50-1 to 50-6 are located in parallel along the X-axis in the order of the drive signal output circuit 50-4, the drive signal output circuit 50-5, and the drive signal output circuit 50-6 from the side 811 toward the side 812 between the integrated circuit 101 and the coupling portion CN2 on the side 813 side of the drive signal output circuits 50-1 to 50-3. In the drive signal output circuit 50-1, the transistors 531 and 532 included in the drive circuit 52a are provided on the surface 815 of the wiring substrate 810, and are located in parallel along the X-axis such that the transistor 531 is located on the side 811 side and the transistor 532 is located on the side 812 side, and the transistors 531 and 532 included in the drive circuit 52b are provided on the surface 815 of the wiring substrate 810 on the +Y side of the transistors 531 and 532 included in the drive circuit 52a, and are located in parallel along the X-axis such that the transistor 531 is located on the side 811 side and the transistor 532 is located on the side 812 side.

In addition, in the drive signal output circuit 50-1, the integrated circuit 500 in which the drive circuit 520 and the amplification control circuit 510 included in the drive circuit 52a and the drive circuit 520 and the amplification control circuit 510 included in the drive circuit 52b are mounted is located between the transistor 531 and the transistor 532 included in the drive circuit 52a of the drive signal output circuit 50-1 and between the transistor 531 and the transistor 532 included in the drive circuit 52b of the drive signal output circuit 50-1, and is provided on the surface 816 of the wiring substrate 810 when the wiring substrate 810 is viewed from a direction along the Z-axis. That is, the integrated circuit 500 of the drive signal output circuit 50-1, and the transistors 531 and 532 included in the drive circuit 52a of the drive signal output circuit 50-1 and the transistors 531 and 532 included in the drive circuit 52b of the drive signal output circuit 50-1 are mounted on different surfaces of the wiring substrate 810, and the integrated circuit 500 of the drive signal output circuit 50-1 is located between the transistors 531 and 532 included in the drive circuit 52a of the drive signal output circuit 50-1 and between the transistors 531 and 532 included in the drive circuit 52b of the drive signal output circuit 50-1.

In other words, the amplification circuit 530 that includes the transistors 531 and 532 and is included in the drive circuit 52a is provided on the surface 815 of the wiring substrate 810, and the amplification control circuit 510 that is mounted in the integrated circuit 500 and is included in the drive circuit 52a is provided on the surface 816 of the wiring substrate 810. At this time, the integrated circuit 500 including the amplification control circuit 510 is located between the transistor 531 and the transistor 532 included in the amplification circuit 530 in a normal direction of the wiring substrate 810 and when the wiring substrate 810 is viewed from a direction along the Z-axis.

Similarly, in each of the drive signal output circuits 50-2 to 50-6, the transistors 531 and 532 included in the drive circuit 52a are provided on the surface 815 of the wiring substrate 810, and are located in parallel along the X-axis such that the transistor 531 is located on side 811 side and the transistor 532 is located on the side 812 side, the transistors 531 and 532 included in the drive circuit 52b are provided on the surface 815 of the wiring substrate 810 on the +Y side of the transistors 531 and 532 included in the corresponding drive circuit 52a, and are located in parallel along the X-axis such that the transistor 531 is located on the side 811 side and the transistor 532 is located on the side 812 side.

In addition, in each of the drive signal output circuits 50-2 to 50-6, the integrated circuit 500 in which the drive circuit 520 and the amplification control circuit 510 included in the drive circuit 52a and the drive circuit 520 and the amplification control circuit 510 included in the drive circuit 52b are mounted is located between the transistors 531 and the transistors 532 included in the drive circuit 52a of the corresponding drive signal output circuits 50-2 to 50-6 and between the transistors 531 and the transistors 532 included in the drive circuit 52b of the corresponding drive signal output circuits 50-2 to 50-6 when the wiring substrate 810 is viewed from the direction along the Z-axis, and is provided on the surface 816 of the wiring substrate 810. That is, in each of the drive signal output circuits 50-2 to 50-6, the integrated circuit 500, and the transistors 531 and 532 included in the drive circuit 52a of the corresponding drive signal output circuits 50-2 to 50-6 and the transistors 531 and 532 included in the drive circuit 52b of the corresponding drive signal output circuits 50-2 to 50-6 are mounted on different surfaces of the wiring substrate 810, and the integrated circuit 500 is located between the transistors 531 and 532 included in the drive circuit 52a of the corresponding drive signal output circuits 50-2 to 50-6 and between the transistors 531 and 532 included in the drive circuit 52b.

In other words, the transistors 531 and 532 of the amplification circuit 530 included in each of the plurality of drive circuits 52 of the head drive module 10 are provided on the surface 815 of the wiring substrate 810 and are not provided on the surface 816 of the wiring substrate 810, and the integrated circuit 500 including the amplification control circuit 510 included in each of the plurality of drive circuits 52 of the head drive module 10 is provided on the surface 816 of the wiring substrate 810 and is not provided on the surface 815 of the wiring substrate 810. That is, in the liquid ejection apparatus 1 of the present embodiment, all of the transistors 531 and 532 of the amplification circuits 530 included in each of the plurality of drive circuits 52 of the head drive module 10 are provided on the surface 815 of the wiring substrate 810, and all of the integrated circuits 500 including the amplification control circuit 510 included in each of the plurality of drive circuits 52 of the head drive module 10 are provided on the surface 816 of the wiring substrate 810.

In the drive circuit substrate 800 configured as described above, the image information signal IP input via the coupling portion CN1 is supplied to the integrated circuit 101. The control circuit 100 and the conversion circuit 120 included in the integrated circuit 101 generate the digital waveform signals dA1 to dA6 and dB1 to dB6 and the data signal DATA based on the image information signal IP, and output the digital waveform signals dA1 to dA6 and dB1 to dB6, and the data signal DATA from the integrated circuit 101. The digital waveform signals dA1 to dA6 and dB1 to dB6 output from the integrated circuit 101 propagate through a wiring pattern (not illustrated) of the wiring substrate 810 and are input to the corresponding drive circuits 52. Each of the drive circuits 52 generates and outputs the corresponding drive signals COMA1 to COMA6 and COMB1 to COMB6 based on the input digital waveform signals dA1 to dA6 and dB1 to dB6. The plurality of signals including the drive signals COMA1 to COMA6 and COMB1 to COMB6 output by the plurality of drive circuits 52 and the data signal DATA output by the integrated circuit 101 are supplied to the liquid ejection module 20 via the coupling portion CN2. As a result, the operation of the liquid ejection module 20 and the ejection of the ink from the liquid ejection module 20 are controlled by the head drive module 10.

Here, in the liquid ejection apparatus 1 of the present embodiment, a case where the integrated circuit 101 including the control circuit 100 is mounted on the wiring substrate 810 in combination with the plurality of drive circuits 52 is exemplified, but the integrated circuit 101 may be mounted on a substrate (not illustrated) different from the substrate as in the drive circuits 52. When the integrated circuit 101 is mounted on the substrate common to the plurality of drive circuits 52 as in the liquid ejection apparatus 1 of the present embodiment, a wiring length along which the signal propagates between the plurality of drive circuits 52 and the integrated circuit 101 can be shortened. As a result, the possibility that a noise or the like is superimposed on the signal propagating between the plurality of drive circuits 52 and the integrated circuit 101 is reduced, and the waveform accuracy of various signals including the drive signal COM output by each of the plurality of drive circuits 52 is improved. On the other hand, the amount of heat generated in the plurality of drive circuits 52 is larger than the amount of heat generated in the integrated circuit 101. By mounting the plurality of drive circuits 52 that generate a large amount of heat and the integrated circuit 101 on different substrates, the concern that heat generated in the plurality of drive circuits 52 has an influence on the integrated circuit 101 is reduced. As a result, the possibility that the operational stability of the integrated circuit 101 is lowered is reduced.

In the head drive module 10 of the liquid ejection apparatus 1 of the present embodiment, the drive circuit substrate 800 as illustrated in FIG. 12 is accommodated in a space formed by the concave portion 711 of the heat sink 710 located on the +Z side of the drive circuit substrate 800 and the concave portion 721 of the heat sink 720 located on the −Z side of the drive circuit substrate 800. At this time, heat generated in the drive circuit substrate 800 which includes heat generated in the transistors 531 and 532 and the integrated circuit 500 provided in the drive circuit substrate 800 is dissipated from both the +Z side and the −Z side of the drive circuit substrate 800 via the heat sinks 710 and 720. As a result, in the liquid ejection apparatus 1 of the present embodiment, the concern that the operational stability of the head drive module 10 is lowered due to heat generated in the plurality of drive circuits 52 of the head drive module 10 is reduced. Therefore, the possibility that the operational stability of the liquid ejection module 20 controlled by the head drive module 10 is lowered is reduced, and the possibility that the ink ejection accuracy from the liquid ejection module 20 is lowered is reduced.

Here, as a heat dissipation structure of the drive circuit 52 in the head drive module 10 of the liquid ejection apparatus 1 of the present embodiment, thermal coupling between the transistors 531 and 532 and the integrated circuit 500 in the head drive module 10 and the heat sink 710 and the heat sink 720 will be described. Here, “thermal coupling” refers to a state in which two or more members are coupled to each other so as to promote heat transfer therebetween, and includes a state in which the two members are in physical contact with each other, a state in which one or a plurality of interposed materials having excellent thermal conductivity are provided between the two members and the two members are coupled to each other via the interposed materials, a state in which there is a gap between the two members but the gap is 100 μm or less, and the like. In addition, as the “interposed material having excellent thermal conductivity” used for the thermal coupling, any substance may be used as long as the substance has high thermal conductivity, but preferably, a substance having high thermal conductivity, a flame-retardant property, an electrical insulation property, and an unevenness following property, for example, conductive grease, a gel sheet, a rubber sheet, or the like that contains silicone or an acrylic resin and has high thermal conductivity can be used.

First, in describing a specific example of the thermal coupling relationship between the transistors 531 and 532 and the integrated circuit 500 in the head drive module 10, and the heat sink 710 and the heat sink 720, an example of a structure of the transistors 531 and 532 included in the drive circuit 52 will be described. As described above, in the liquid ejection apparatus 1 of the present embodiment, the transistor 531 is an NPN type bipolar transistor, the transistor 532 is a PNP type bipolar transistor, and the transistor 531 and the transistor 532 constitute a complementary pair. Therefore, the transistor 531 and the transistor 532 have the same structure except that the type of the mounted semiconductor elements is different. In the following description, the structure of the transistor 531 will be described in detail with reference to the drawings, and the structure of the transistor 532 will not be illustrated in the drawing and description thereof will be simplified or omitted.

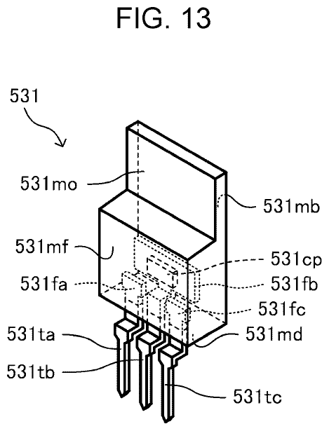

FIG. 13 is a view illustrating an example of the structure of the transistor 531. As illustrated in FIG. 13, the transistor 531 includes a mold portion 531mo, lead frames 531fa, 531fb, and 531fc, a semiconductor chip 531cp, and external coupling terminals 531ta, 531tb, and 531tc.

The mold portion 531mo has a surface 531mb having the largest area in the mold portion 531mo, and a surface 531mf located to face the surface 531mb and having an area approximately equivalent to the area of the surface 531mb in the mold portion 531mo, or a second largest area next to the surface 531mb. That is, the transistor 531 has the surface 531mb and the surface 531mf, the area of the surface 531mb is larger than the area of the surface 531mf, and the surface 531mb and the surface 531mf are located to face each other. In addition, the lead frames 531fa, 531fb, and 531fc and the semiconductor chip 531cp are provided inside the mold portion 531mo. That is, the mold portion 531mo is formed to cover the lead frames 531fa, 531fb, and 531fc and the semiconductor chip 531cp. Such a mold portion 531mo is made of a flame-retardant epoxy resin or the like, and functions as a protective member that protects the semiconductor chip 531cp provided inside the mold portion 531mo from the outside air and impact. The mold portion 531mo is not limited to a case of being made of a single material, and for example, from the viewpoint of improving a heat dissipation property, the surface 531mb may be made of a tin-based alloy material or a copper-based alloy material. In this case, the tin-based alloy material or the copper-based alloy material constituting the surface 531mb may be integrally formed with the lead frame 531fb described later.

Lead frame 531fb is made of a material in which a copper-based alloy material is used as a base material. The lead frame 531fb includes a flat plate that extends along a plane formed by at least one of the surfaces 531mb and 531mf inside the mold portion 531mo, and the flat plate is located in the vicinity of the surface 531mb rather than the surface 531mf. That is, the lead frame 531fb is located such that thermal resistance between the lead frame 531fb and the surface 531mb is smaller than thermal resistance between the lead frame 531fb and the surface 531mf. The semiconductor chip 531cp, which is an NPN-type bipolar transistor element, is mounted on the lead frame 531fb. At this time, the semiconductor chip 531cp is fixed to the lead frame 531fb by, for example, solder with a high melting point or the like. As a result, the semiconductor chip 531cp and the lead frame 531fb are electrically coupled to each other. That is, the transistor 531 includes the semiconductor chip 531cp, and the semiconductor chip 531cp is fixed to the lead frame 531fb at the inside of the mold portion 531mo. Therefore, thermal resistance between the semiconductor chip 531cp and the surface 531mb is smaller than thermal resistance between the semiconductor chip 531cp and the surface 531mf.

In addition, each of the lead frame 531fa and the lead frame 531fc provided inside the mold portion 531mo is made of a material in which a copper-based alloy material is used as a base material. Each of the lead frame 531fa and the lead frame 531fc is electrically coupled to the semiconductor chip 531cp by a bonding wire (not illustrated) such as an aluminum wire or a gold wire. As a result, at the inside of the mold portion 531mo, each of a base electrode, a collector electrode, and an emitter electrode of the semiconductor chip 531cp, which are NPN type bipolar transistor elements, is electrically coupled to the corresponding lead frame 531fa, 531fb, or 531fc.

The external coupling terminals 531ta, 531tb, and 531tc are coupling terminals provided outside the mold portion 531mo in order to mount the transistor 531 on the wiring substrate 810, and are made of a material in which a copper-based alloy material is used as a base material.

The external coupling terminal 531ta is integrally configured with the lead frame 531fa, and extends from a surface 531md of the mold portion 531mo, which intersect both the surface 531mb and the surface 531mf, toward the outside of the mold portion 531mo. The external coupling terminal 531tb is integrally configured with the lead frame 531fb and extends from the surface 531md toward the outside of the mold portion 531mo. The external coupling terminal 531tc is integrally configured with the lead frame 531fc and extends from the surface 531md toward the outside of the mold portion 531mo. That is, the external coupling terminals 531ta, 531tb, and 531tc function as a base terminal, a collector terminal, and an emitter terminal of the transistor 531, and extend from the surface 531md of the mold portion 531mo in a direction away from the mold portion 531mo. At this time, the external coupling terminals 531ta, 531tb, and 531tc are subjected to forming processing so as to extend in a direction away from the mold portion 531mo along a plane in which the surface 531mf extends as illustrated in FIG. 13.

Here, in the liquid ejection apparatus 1 of the present embodiment, description will be made on the assumption that the base electrode of the semiconductor chip 531cp is electrically coupled to the lead frame 531fa, the collector electrode of the semiconductor chip 531cp is electrically coupled to the lead frame 531fb, and the emitter electrode of the semiconductor chip 531cp is electrically coupled to the lead frame 531fc. That is, the external coupling terminal 531ta corresponds to the base terminal of the transistor 531, the external coupling terminal 531tb corresponds to the collector terminal of the transistor 531, and the external coupling terminal 531tc corresponds to the emitter terminal of the transistor 531. A relationship between each of the external coupling terminals 531ta, 531tb, and 531tc and the base terminal, the emitter terminal, and the collector terminal of the transistor 531 is not limited to this.

As described above, in the liquid ejection apparatus 1 of the present embodiment, the transistor 531 included in each of the drive circuits 52a and 52b of each of the drive signal output circuits 50-1 to 50-6 is a so-called single in-line package (SIP) type bipolar transistor in which the external coupling terminals 531ta, 531tb, and 531tc electrically coupled to the wiring substrate 810 are provided in a row on the surface 531md of the mold portion 531mo, and is mounted on the surface 815 of the wiring substrate 810 after being subjected to forming processing in a predetermined shape into the external coupling terminals 531ta, 531tb, and 531tc extending from the surface 531md of the mold portion 531mo in the direction away from the mold portion 531mo.

Here, as described above, the transistor 531 and the transistor 532 have the same structure. That is, the transistor 532 includes a mold portion 532mo, surfaces 532mb, 532mf, 532md, lead frames 532fa, 532fb, 532fc, a semiconductor chip 532cp, and external coupling terminals 532ta, 532tb, and 532tc, each corresponding to each of the mold portion 531mo, the surfaces 531mb, 531mf, 531md, the lead frames 531fa, 531fb, 531fc, the semiconductor chip 531cp, and the external coupling terminals 531ta, 531tb, and 531tc of the transistor 531. At this time, an area of the surface 532mb included in the transistor 532 is larger than an area of the surface 532mf, and the surface 532mb and the surface 532mf are located to face each other. The transistor 532 includes the semiconductor chip 532cp inside the mold portion 532mo, and the semiconductor chip 532cp is fixed to the lead frame 532fb at the inside of the mold portion 532mo. Therefore, thermal resistance between the semiconductor chip 532cp and the surface 532mb is smaller than thermal resistance between the semiconductor chip 532cp and the surface 532mf. In addition, the external coupling terminals 532ta, 532tb, and 532tc electrically coupled to the wiring substrate 810 of the transistor 532 are provided in a row on the surface 532md of the mold portion 532mo.

That is, the transistor 532 is an SIP type bipolar transistor. The transistor 532 is mounted on the surface 815 of the wiring substrate 810 after being subjected to forming processing in a predetermined shape into the external coupling terminals 532ta, 532tb, and 532tc extending from the surface 532md of the mold portion 532mo.

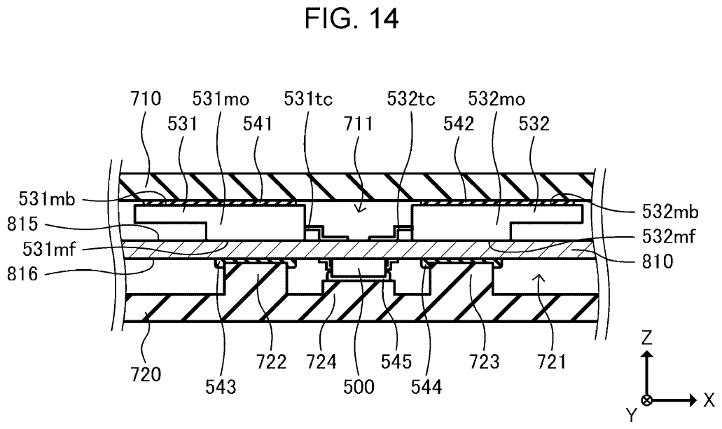

FIG. 14 is a view illustrating an example of thermal coupling between the transistors 531 and 532 and the integrated circuit 500, and the heat sink 710 and the heat sink 720. Here, FIG. 14 is a cross-sectional view when the head drive module 10 is cut to pass through the transistors 531 and 532 and the integrated circuit 500 of one drive circuit 52 among the plurality of drive circuits 52 of the head drive module 10 are passed.

As illustrated in FIG. 14, in the head drive module 10, the drive circuit substrate 800 is accommodated in a space formed by the concave portion 711 and the concave portion 721 such that the surface 815 of the wiring substrate 810 is located on the +Z side and the surface 816 of the wiring substrate 810 is located on the −Z side. The transistors 531 and 532 and the integrated circuit 500 are mounted on the wiring substrate 810 of the drive circuit substrate 800.

The transistor 531 is provided on the surface 815 of the wiring substrate 810 such that the mold portion 531mo is located on the −X side, the external coupling terminals 531ta, 531tb, and 531tc are located on the +X side, and at least a part of the surface 531mf is in contact with the surface 815. Then, each of the external coupling terminals 531ta, 531tb, and 531tc is electrically coupled to the wiring substrate 810 by solder or the like, and the transistor 531 is mounted on the wiring substrate 810. The transistor 532 is provided on the surface 815 of the wiring substrate 810 such that the mold portion 532mo is located on the +X side, the external coupling terminals 532ta, 532tb, and 532tc are located on the −X side, and at least a part of the surface 532mf is in contact with the surface 815. Then, each of the external coupling terminals 532ta, 532tb, and 532tc is electrically coupled to the wiring substrate 810 by solder or the like, and the transistor 532 is mounted on the wiring substrate 810. That is, the transistor 531 and the transistor 532 are mounted on the surface 815 of the wiring substrate 810 such that the external coupling terminals 531ta, 531tb, and 531tc and the external coupling terminals 532ta, 532tb, and 532tc face each other.

At least a part of the integrated circuit 500 is located between the transistor 531 and the transistor 532 when viewed from a direction along the Z-axis, and is mounted on the surface 816 of the wiring substrate 810. At this time, the integrated circuit 500 is mounted on the surface 816 of the wiring substrate 810 such that at least a part of the integrated circuit 500 overlaps with at least a part of the transistor 531 and at least a part of the integrated circuit 500 overlaps with at least a part of the transistor 532 when viewed from the direction along the Z-axis.

Here, the transistor 531 and the transistor 532 are mounted on the surface 815 of the wiring substrate 810 such that the external coupling terminals 531ta, 531tb, and 531tc and the external coupling terminals 532ta, 532tb, and 532tc face each other. Therefore, the integrated circuit 500 is mounted on the surface 816 of the wiring substrate 810 to be located between the external coupling terminals 531ta, 531tb, and 531tc and the external coupling terminals 532ta, 532tb, and 532tc when viewed from the direction along the Z-axis. As a result, a wiring length through which the amplification control signal Hdr output to the transistor 531 by the integrated circuit 500 propagates and a wiring length through which the amplification control signal Ldr output to the transistor 532 by the integrated circuit 500 propagates can be shortened. As a result, the possibility that a noise or the like is superimposed on the amplification control signals Hdr and Ldr is reduced, and the drive control of the transistors 531 and 532 is improved. Therefore, the waveform accuracy of the drive signal COM output by the drive circuit 52 is improved, and the ejection accuracy of the ink from the liquid ejection module 20 is improved.

The heat sink 720 is located on the −Z side of the drive circuit substrate 800 and on the surface 816 side of the wiring substrate 810. The heat sink 720 includes convex portions 722, 723, and 724 protruding to the +Z side.

The convex portion 722 is formed in correspondence with the transistor 531. Specifically, the convex portion 722 is located such that at least a part thereof overlaps with at least a part of the surface 531mf of the transistor 531 when the head drive module 10 is viewed from the direction along the Z-axis. In addition, a heat conductive member 543 as the above-described interposed material is located between the wiring substrate 810 and the convex portion 722 in the direction along the Z-axis. In a state in which the drive circuit substrate 800 is accommodated in the space formed by the concave portion 711 and the concave portion 721, the convex portion 722 is in contact with one surface of the heat conductive member 543, the other surface of the heat conductive member 543 is in contact with the surface 816 of the wiring substrate 810, and the surface 531mf of the transistor 531 is in contact with a region of the surface 815 that faces the surface 816, with which the heat conductive member 543 is in contact, along the Z-axis. That is, the convex portion 722, the surface 531mf, and the heat conductive member 543 are located to overlap with each other at least partially when viewed from the direction along the Z-axis. As a result, the convex portion 722 and the surface 531mf of the transistor 531 are thermally coupled via the heat conductive member 543 and the wiring substrate 810. Therefore, heat generated in the transistor 531 is efficiently transferred to the heat sink 720 via the wiring substrate 810 and the heat conductive member 543. Therefore, the dissipation efficiency of heat generated in the transistor 531 is improved.

Here, as described above, the heat conductive member 543 as the interposed portion has high thermal conductivity and is a substance having a flame-retardant property, an electrical insulation property, and an unevenness following property, and for example, conductive grease, a gel sheet, a rubber sheet, or the like is preferably used. As a result, the heat conductive member 543 functions as a heat conductive member through which heat generated in the transistor 531 propagates to the heat sink 720, a member that insulates between the wiring substrate 810 and the heat sink 720, and a member that enhances adhesion between the wiring substrate 810 and the heat sink 720.

As described above, the surface 531mf of the transistor 531 is thermally coupled to the surface 815 of the wiring substrate 810, and the surface 816 of the wiring substrate 810 is thermally coupled to the heat sink 720. Therefore, the heat sink 720 is thermally coupled to the amplification circuit 530 including the transistor 531 via the wiring substrate 810. As a result, heat generated in the transistor 531, that is, heat generated in the amplification circuit 530 including the transistor 531 is efficiently transferred to the heat sink 720 and is dissipated to the outside. At this time, the liquid ejection apparatus 1 of the present embodiment includes the heat conductive member 543 that is located between the heat sink 720 and the wiring substrate 810 and between the convex portion 722 of the heat sink 720 and the surface 816 of the wiring substrate 810, and is in contact with both the heat sink 720 and the wiring substrate 810. That is, the surface 816 of the wiring substrate 810 and the heat sink 720 are thermally and physically coupled via the heat conductive member 543 having an insulation property. As a result, the heat dissipation efficiency between the surface 816 of the wiring substrate 810 and the heat sink 720 can be raised, and the insulation performance between the surface 816 of the wiring substrate 810 and the heat sink 720 can be raised.

Here, in a state in which the drive circuit substrate 800 is accommodated in the space formed by the concave portion 711 and the concave portion 721, when the head drive module 10 is viewed from the direction along the Z-axis, it is more preferable that the entire convex portion 722 is located to overlap with at least a part of the surface 531mf of the transistor 531, or at least a part of the convex portion 722 is located to overlap with the entire surface 531mf of the transistor 531. As a result, heat generated in the transistor 531 is more efficiently transferred to the heat sink 720 via the wiring substrate 810 and the heat conductive member 543. As a result, the dissipation efficiency of heat generated in the transistor 531 is further improved.

As illustrated in FIG. 12, a plurality of the transistors 531 are arranged in parallel on the surface 815 of the wiring substrate 810 along the Y-axis. The heat sink 720 may include the convex portion 722 that individually corresponds to each of the plurality of transistors 531 arranged in parallel along the Y-axis, or may include the convex portion 722 that is common to some of the plurality of transistors 531 arranged in parallel along the Y-axis. In addition, a notch, a through-hole, or the like that is continuous from the −X side to the +X side of the convex portion 722 along the X-axis may be formed in the convex portion 722. As a result, a gas containing an airflow sent out by the cooling fan 713 can efficiently circulate inside the space formed by the concave portion 711 and the concave portion 721. Therefore, the cooling efficiency in the head drive module 10 is improved.

The convex portion 723 is formed in correspondence with the transistor 532. Specifically, the convex portion 723 is located such that at least a part thereof overlaps with at least a part of the surface 532mf of the transistor 532 when the head drive module 10 is viewed from the direction along the Z-axis. In addition, the heat conductive member 544 as the above-described interposed material is located between the wiring substrate 810 and the convex portion 723 in the direction along the Z-axis. In a state in which the drive circuit substrate 800 is accommodated in the space formed by the concave portion 711 and the concave portion 721, the convex portion 723 is in contact with one surface of the heat conductive member 544, the other surface of the heat conductive member 544 is in contact with the surface 816 of the wiring substrate 810, and the surface 532mf of the transistor 532 is in contact with a region of the surface 815 that faces the surface 816, with which the heat conductive member 544 is in contact, along the Z-axis. That is, the convex portion 723, the surface 532mf, and the heat conductive member 544 are located to overlap with each other at least partially when viewed from the direction along the Z-axis. As a result, the convex portion 723 and the surface 532mf of the transistor 532 are thermally coupled via the heat conductive member 544 and the wiring substrate 810. Therefore, heat generated in the transistor 532 is efficiently transferred to the heat sink 720 via the wiring substrate 810 and the heat conductive member 544. Therefore, the dissipation efficiency of heat generated in the transistor 532 is improved.

Here, as described above, the heat conductive member 544 as the interposed portion has high thermal conductivity and is a substance having a flame-retardant property, an electrical insulation property, and an unevenness following property, and for example, conductive grease, a gel sheet, a rubber sheet, or the like is preferably used. As a result, the heat conductive member 544 functions as a heat conductive member through which heat generated in the transistor 532 propagates to the heat sink 720, a member that insulates between the wiring substrate 810 and the heat sink 720, and a member that enhances adhesion between the wiring substrate 810 and the heat sink 720.

As described above, the surface 532mf of the transistor 532 is thermally coupled to the surface 815 of the wiring substrate 810, and the surface 816 of the wiring substrate 810 is thermally coupled to the heat sink 720. Therefore, the heat sink 720 is thermally coupled to the amplification circuit 530 including the transistor 532 via the wiring substrate 810. As a result, heat generated in the transistor 532, that is, heat generated in the amplification circuit 530 including the transistor 532 is efficiently transferred to the heat sink 720 and is dissipated to the outside. At this time, the liquid ejection apparatus 1 of the present embodiment includes the heat conductive member 544 that is located between the heat sink 720 and the wiring substrate 810 and between the convex portion 723 of the heat sink 720 and the surface 816 of the wiring substrate 810, and is in contact with both the heat sink 720 and the wiring substrate 810. That is, the surface 816 of the wiring substrate 810 and the heat sink 720 are thermally and physically coupled via the heat conductive member 544 having an insulation property. As a result, the heat dissipation efficiency between the surface 816 of the wiring substrate 810 and the heat sink 720 can be raised, and the insulation performance between the surface 816 of the wiring substrate 810 and the heat sink 720 can be raised.

Here, in a state in which the drive circuit substrate 800 is accommodated in the space formed by the concave portion 711 and the concave portion 721, when the head drive module 10 is viewed from the direction along the Z-axis, it is more preferable that the entire convex portion 723 is located to overlap with at least a part of the surface 532mf of the transistor 532, or at least a part of the convex portion 723 is located to overlap with the entire surface 532mf of the transistor 532. As a result, heat generated in the transistor 532 is more efficiently transferred to the heat sink 720 via the wiring substrate 810 and the heat conductive member 544. As a result, the dissipation efficiency of heat generated in the transistor 532 is further improved.

As illustrated in FIG. 12, a plurality of the transistors 532 are arranged in parallel on the surface 815 of the wiring substrate 810 along the Y-axis. The heat sink 720 may include the convex portion 723 that individually corresponds to each of the plurality of transistors 532 arranged in parallel along the Y-axis, or may include the convex portion 723 that is common to some of the plurality of transistors 532 arranged in parallel along the Y-axis. In addition, a notch, a through-hole, or the like that is continuous from the −X side to the +X side of the convex portion 723 along the X-axis may be formed in the convex portion 723. As a result, a gas containing an airflow sent out by the cooling fan 713 can efficiently circulate inside the space formed by the concave portion 711 and the concave portion 721. Therefore, the cooling efficiency in the head drive module 10 is improved.

The convex portion 724 is formed in correspondence with the integrated circuit 500. Specifically, the convex portion 724 is located between the convex portion 722 and the convex portion 723 when the head drive module 10 is viewed from the direction along the Y-axis, and at least a part of the convex portion 724 is located to overlap with at least a part of the integrated circuit 500 when the head drive module 10 is viewed from the direction along the Z-axis. In addition, a heat conductive member 545 as the above-described interposed material is located between the integrated circuit 500 and the convex portion 724 in the direction along the Z-axis. In a state where the drive circuit substrate 800 is accommodated in the space formed by the concave portion 711 and the concave portion 721, the convex portion 724 is in contact with one surface of the heat conductive member 545, and the other surface of the heat conductive member 545 is in contact with the integrated circuit 500. That is, the convex portion 724, the integrated circuit 500, and the heat conductive member 545 are located to overlap with each other at least partially when viewed from the direction along the Z-axis. As a result, the convex portion 724 and the integrated circuit 500 are thermally coupled via the heat conductive member 545. Therefore, heat generated in the integrated circuit 500 is efficiently transferred to the heat sink 720 via the heat conductive member 545. Therefore, the dissipation efficiency of heat generated in the integrated circuit 500 is improved.

Here, as described above, the heat conductive member 545 as the interposed portion has high thermal conductivity and is a substance having a flame-retardant property, an electrical insulation property, and an unevenness following property, and for example, conductive grease, a gel sheet, a rubber sheet, or the like is preferably used. As a result, the heat conductive member 545 functions as a heat conductive member through which heat generated in the integrated circuit 500 propagates to the heat sink 720, and also functions as a member that insulates between the integrated circuit 500 and the heat sink 720 and a member that enhances the adhesion between the integrated circuit 500 and the heat sink 720.

As described above, the integrated circuit 500 is thermally coupled to the heat sink 720. In other words, the head drive module 10 includes the heat sink 720 thermally coupled to the amplification control circuit 510 included in the integrated circuit 500. As a result, heat generated in the integrated circuit 500 and heat generated in the amplification control circuit 510 mounted on the integrated circuit 500 are efficiently transferred to the heat sink 720 and dissipated to the outside. At this time, in the liquid ejection apparatus 1 of the present embodiment, the heat conductive member 545 is located between the heat sink 720 and the integrated circuit 500 and between the convex portion 724 of the heat sink 720 and the integrated circuit 500, and is in contact with both the heat sink 720 and the integrated circuit 500. That is, the integrated circuit 500 and the heat sink 720 are thermally and physically coupled to each other via the heat conductive member 545 having an insulation property. As a result, the heat dissipation efficiency between the integrated circuit 500 and the heat sink 720 can be raised, and the insulation performance between the integrated circuit 500 and the surface 816 of the wiring substrate 810 provided with the integrated circuit 500 and the heat sink 720 can be raised.

Here, in a state in which the drive circuit substrate 800 is accommodated in the space formed by the concave portion 711 and the concave portion 721, when the head drive module 10 is viewed from the direction along the Z-axis, it is more preferable that the entire convex portion 724 is located to overlap with at least a part of the integrated circuit 500, or at least a part of the convex portion 724 is located to overlap with the entire integrated circuit 500. As a result, heat generated in the integrated circuit 500 is more efficiently transferred to the heat sink 720 via the heat conductive member 545. As a result, the dissipation efficiency of heat generated in the transistor 532 is improved.

As illustrated in FIG. 12, a plurality of the integrated circuits 500 are arranged in parallel on the surface 816 of the wiring substrate 810 along the Y-axis. The heat sink 720 may include the convex portion 724 that is individually provided for each of the plurality of integrated circuits 500 arranged in parallel along the Y-axis, or may include the convex portion 724 that is common to some of the plurality of integrated circuits 500 arranged in parallel along the Y-axis. In addition, a notch or a through-hole that is continuous from the −X side to the +X side of the convex portion 724 along the X-axis may be formed in the convex portion 724. As a result, a gas containing an airflow sent out by the cooling fan 713 can efficiently circulate inside the space formed by the concave portion 711 and the concave portion 721. As a result, the cooling efficiency of the entire drive circuit substrate 800 is improved.

As described above, the heat sink 720 includes the convex portion 724 that protrudes to the +Z side and is thermally coupled to the amplification control circuit 510 included in the integrated circuit 500, the convex portion 722 that protrudes to the +Z side and is thermally coupled to the transistor 531 included in the amplification circuit 530, and the convex portion 723 that protrudes to the +Z side and is thermally coupled to the transistor 532 included in the amplification circuit 530. In other words, the heat sink 720 includes a concave portion between the convex portion 722 and the convex portion 724 and between the convex portion 723 and the convex portion 724. As a result, the possibility that heat of the amplification control circuit 510 included in the integrated circuit 500 which is dissipated via the convex portion 724 has an influence on the transistors 531 and 532 included in the amplification circuit 530 is reduced, and the possibility that heat of the transistor 531 included in the amplification circuit 530 which is dissipated via the convex portion 722 and heat of the transistor 532 included in the amplification circuit 530 which is dissipated via the convex portion 723 have an influence on the amplification control circuit 510 included in the integrated circuit 500 is reduced. Further, the heat sink 720 includes a concave portion between the convex portion 722 and the convex portion 724 and between the convex portion 723 and the convex portion 724, so that an electronic component having a large size in the Z-axis direction can be mounted on the surface 816 of the wiring substrate 810. As a result, the type of electronic components that can be mounted on the wiring substrate 810 is increased, and the versatility of the drive circuit substrate 800 including the wiring substrate 810 is improved.

The heat sink 710 is located on the +Z side of the drive circuit substrate 800 and on the surface 815 side of the wiring substrate 810. In addition, in the direction along the Z-axis, the heat conductive member 541 as the above-described interposed material is located between the heat sink 710 and the surface 531mb of the transistor 531, and the heat conductive member 542 as the above-described interposed material is located between the heat sink 710 and the surface 532mb of the transistor 532. In a state in which the drive circuit substrate 800 is accommodated in the space formed by the concave portion 711 and the concave portion 721, the surface 531mb of the transistor 531 is in contact with one surface of the heat conductive member 541, the other surface of the heat conductive member 541 is in contact with the heat sink 710, the surface 532mb of the transistor 532 is in contact with one surface of the heat conductive member 542, and the other surface of the heat conductive member 542 is in contact with the heat sink 710. That is, the heat sink 710 and the surface 531mf of the transistor 531 are thermally coupled via the heat conductive member 541, and the heat sink 710 and the surface 532mf of the transistor 532 are thermally coupled via the heat conductive member 542. As a result, the transistor 531 and the heat sink 710 are thermally coupled, and the transistor 532 and the heat sink 710 are thermally coupled. Therefore, heat generated in the transistor 531 is efficiently transferred to the heat sink 710 via the heat conductive member 541, and heat generated in the transistor 532 is efficiently transferred to the heat sink 710 via the heat conductive member 542. Therefore, the dissipation efficiency of heat generated by the transistors 531 and 532, that is, heat generated by the amplification circuit 530 including the transistors 531 and 532 is improved.

Here, as described above, the heat conductive members 541 and 542 as the interposed portion have high thermal conductivity and are substances having a flame-retardant property, an electrical insulation property, and an unevenness following property, and for example, conductive grease, a gel sheet, a rubber sheet, or the like is preferably used. As a result, the heat conductive members 541 and 542 function as a heat conductive member through which heat generated by the transistors 531 and 532 propagates to the heat sink 710, and also function as a member that insulates between the transistors 531 and 532 and the heat sink 710 and a member that enhances the adhesion between the transistors 531 and 532 and the heat sink 710.

As described above, the surface 531mb of the transistor 531 and the surface 532mb of the transistor 532 are thermally coupled to the heat sink 710. In other words, the amplification circuit 530 including the transistor 531 and the transistor 532 is thermally coupled to the heat sink 710. As a result, heat generated by the transistors 531 and 532, that is, heat generated by the amplification circuit 530 including the transistors 531 and 532 is efficiently transferred to the heat sink 710 and dissipated to the outside. At this time, the liquid ejection apparatus 1 of the present embodiment includes the heat conductive member 541 that is located between the heat sink 710 and the surface 531mb of the transistor 531 and is in contact with both the heat sink 710 and the surface 531mb of the transistor 531, and the heat conductive member 542 that is located between the heat sink 710 and the surface 532mb of the transistor 532 and is in contact with both the heat sink 710 and the surface 532mb of the transistor 532. That is, the heat sink 710 and the surface 531mb of the transistor 531 are thermally and physically coupled to each other via the heat conductive member 541 having an insulation property, and the heat sink 710 and the surface 532mb of the transistor 532 are thermally and physically coupled to each other via the heat conductive member 542 having an insulation property. As a result, the heat dissipation efficiency between the transistors 531 and 532 and the heat sink 710 can be raised, and the insulation performance between the transistors 531 and 532 and the heat sink 710 can be raised.

In the liquid ejection apparatus 1 of the present embodiment, as described above, the heat dissipation property of the heat sink 710 is higher than the heat dissipation property of the heat sink 720. The heat sink 710 having such excellent heat dissipation property can further raise the heat dissipation efficiency for the transistors 531 and 532 by dissipating heat generated in the transistors 531 and 532 without via the wiring substrate 810.

In addition, at this time, in the liquid ejection apparatus 1 of the present embodiment, the heat sink 710 having an excellent heat dissipation property is thermally coupled to the surface 531mb having small thermal resistance from the semiconductor chip 531cp in the transistor 531 without via the wiring substrate 810, and is thermally coupled to the surface 532mb having small thermal resistance from the semiconductor chip 532cp in the transistor 532 without via the wiring substrate 810. As a result, heat generated in the semiconductor chips 531cp and 532cp, which generate particularly large heat, in the transistors 531 and 532 can be efficiently dissipated via the heat sink 710. Therefore, the heat dissipation efficiency for the transistors 531 and 532 is further improved.

In FIG. 14, a case where the heat sink 710 does not include a convex portion is illustrated, but the heat sink 710 may have a convex portion corresponding to the surface 531mb of the transistor 531 and a convex portion corresponding to the surface 532mb of the transistor 532 in a similar manner as in the heat sink 720. In addition, the heat sinks 710 and 720 may have a structure including a plurality of fins formed toward the outside of the head drive module 10. As a result, an area of the heat sinks 710 and 720 increases, and the heat dissipation efficiency of the heat sinks 710 and 720 is further improved.

Here, the amplification control circuit 510 is an example of a base drive signal output circuit, the digital waveform signal dO input to the amplification control circuit 510 is an example of a digital signal, the drive waveform signal WS output by the amplification control circuit 510 is an example of a base drive signal, the amplification circuit 530 is an example of an amplification circuit, the drive signal COM output by the amplification circuit 530 is an example of a drive signal, the transistor 531 of the amplification circuit 530 is an example of a first transistor, the transistor 532 of the amplification circuit 530 is an example of a second transistor, the piezoelectric element driven by the drive signal COM supplied is an example of a capacitive load, at least one of the liquid ejection module 20 and the ejection module 23 is an example of an ejection head, and the head drive module 10 including the drive circuit 52 is an example of a capacitive load drive circuit. In addition, the surface 531mb of the transistor 531 is an example of a first surface, the surface 531mf of the transistor 531 is an example of a second surface, the surface 532mb of the transistor 532 is an example of a third surface, the surface 532mf of the transistor 532 is an example of a fourth surface, the semiconductor chip 531cp is an example of a first semiconductor chip, and the semiconductor chip 532cp is an example of a second semiconductor chip. In addition, the surface 815 of the wiring substrate 810 is an example of a first substrate surface, the surface 815 of the wiring substrate 810 is an example of a second substrate surface, the heat sink 710 is an example of a first heat dissipation member, the heat sink 720 is an example of a second heat dissipation member, the space formed by the concave portion 711 of the heat sink 710 and the concave portion 721 of the heat sink 720 is an example of an accommodation portion, the cooling fan 713 is an example of an air cooling mechanism, the heat conductive member 541 is an example of a first heat conductive member, the heat conductive member 542 is an example of a second heat conductive member, and at least one of the heat conductive member 543 and the heat conductive member 544 is an example of a third heat conductive member.

### 5. Operational Effect

As described above, the liquid ejection apparatus 1 of the present embodiment includes the head drive module 10 including the heat sinks 710 and 720 and the drive circuit substrate 800, in which the drive circuit substrate 800 includes the amplification control circuit 510 to which the digital waveform signal dO is input and which outputs the drive waveform signal WS, the amplification circuit 530 that includes the transistors 531 and 532, amplifies the drive waveform signal WS by driving of the transistors 531 and 532, and outputs the drive signal COM for driving the piezoelectric element 60, and the wiring substrate 810 provided with the amplification control circuit 510 and the amplification circuit 530.

In the head drive module 10, the surface 531mb of the transistor 531 and the surface 532mb of the transistor 532 are thermally coupled to the heat sink 710, the surface 531mf, which is located to face the surface 531mb, in the transistor 531, and the surface 532mf, which is located to face the surface 532mb, in the transistor 532 are thermally coupled to the surface 815 of the wiring substrate 810, and the surface 816, which is located facing the surface 815, in the wiring substrate 810 is thermally coupled to the heat sink 720. As a result, heat generated in the transistor 531 and the transistor 532 is dissipated from the surface 531mb and the surface 532mb by the heat sink 710, and is also dissipated from the surface 531mf and the surface 532mf by the heat sink 720 via the wiring substrate 810. That is, heat generated in the transistors 531 and 532 is dissipated from both surfaces of the transistors 531 and 532 by the heat sinks 710 and 720. As a result, the dissipation efficiency of heat from the transistors 531 and 532 is improved, and the possibility that the transistors 531 and 532 become high temperature is reduced. Therefore, the possibility that the operational stability of the drive circuit 52 including the amplification circuit 530 is lowered is reduced. Therefore, the possibility that the waveform accuracy of the drive signal COM output by the drive circuit 52 and the head drive module 10 including the drive circuit 52 is lowered is reduced.

At this time, the heat dissipation property of the heat sink 710 that is thermally coupled to the transistors 531 and 532 without via the wiring substrate 810 is made higher than the heat dissipation property of the heat sink 720 that is thermally coupled to the transistors 531 and 532 via the wiring substrate 810. Therefore, the dissipation efficiency of heat from the transistors 531 and 532 is further improved. Therefore, the possibility that the transistors 531 and 532 become high temperature is further reduced. As a result, the possibility that the operational stability of the drive circuit 52 including the amplification circuit 530 is lowered is further reduced, and the possibility that the waveform accuracy of the drive signal COM output by the drive circuit 52 and the head drive module 10 including the drive circuit 52 is lowered is further reduced.

In addition, by making the area of the surface 531mb in the transistor 531 larger than the area of the surface 531mf, and making the area of the surface 532mb in the transistor 532 larger than the area of the surface 532mf, the dissipation efficiency of heat of the transistors 531 and 532 by the heat sink 710 is further improved. Therefore, the possibility that the transistors 531 and 532 become high temperature is further reduced. As a result, the possibility that the operational stability of the drive circuit 52 including the amplification circuit 530 is lowered is further reduced, and the possibility that the waveform accuracy of the drive signal COM output by the drive circuit 52 and the head drive module 10 including the drive circuit 52 is lowered is further reduced.

Further, in the transistor 531, the thermal resistance between the semiconductor chip 531cp and the surface 531mb is smaller than the thermal resistance between the semiconductor chip 531cp and the surface 531mf, and in the transistor 532, the thermal resistance between the semiconductor chip 532cp and the surface 532mb is smaller than the thermal resistance between the semiconductor chip 532cp and the surface 532mf. Therefore, the dissipation efficiency of heat of the transistors 531 and 532 by the heat sink 710 is further improved. Therefore, the possibility that the transistors 531 and 532 become high temperature is further reduced. As a result, the possibility that the operational stability of the drive circuit 52 including the amplification circuit 530 is lowered is further reduced, and the possibility that the waveform accuracy of the drive signal COM output by the drive circuit 52 and the head drive module 10 including the drive circuit 52 is lowered is further reduced.

In addition, the heat conductive member 541 having high thermal conductivity, a flame-retardant property, an electrical insulation property, and an unevenness following property is located between the surface 531mb of the transistor 531 and the heat sink 710, the heat conductive member 542 having high thermal conductivity, a flame-retardant property, an electrical insulation property, and an unevenness following property is located between the surface 532mb of the transistor 532 and the heat sink 710, and the heat conductive members 543 and 544 having high thermal conductivity, a flame-retardant property, an electrical insulation property, and an unevenness following property are located between the surface 816 of the wiring substrate 810 and the heat sink 720. Therefore, the insulation performance between the heat sinks 710 and 720 and the wiring substrate 810 is improved, and the adhesion between the heat sinks 710 and 720, and the transistors 531 and 532 and the wiring substrate 810 is improved. Therefore, the dissipation efficiency of heat of the transistors 531 and 532 by the heat sinks 710 and 720 is further improved. Therefore, the possibility that the transistors 531 and 532 become high temperature is further reduced. As a result, the possibility that the operational stability of the drive circuit 52 including the amplification circuit 530 is lowered is further reduced, and the possibility that the waveform accuracy of the drive signal COM output by the drive circuit 52 and the head drive module 10 including the drive circuit 52 is lowered is further reduced.

Further, the amplification circuit 530 including the transistor 531 and the transistor 532 is provided on the surface 815 of the wiring substrate 810, and the amplification control circuit 510 that outputs the drive waveform signal WS is provided on the surface 816 of the wiring substrate 810. Therefore, heat generated in the amplification circuit 530 and heat generated in the amplification control circuit 510 affect each other, and the possibility that the temperature of the drive circuit 52 rises is also reduced. Therefore, the possibility that the operational stability of the drive circuit 52 is lowered is reduced, and the possibility that the waveform accuracy of the drive signal COM output by the drive circuit 52 and the head drive module 10 including the drive circuit 52 is lowered is reduced.

At this time, all of the plurality of amplification circuits 530 included in the plurality of drive circuits 52 provided in the wiring substrate 810 are provided on the surface 815 of the wiring substrate 810, and all of the plurality of amplification control circuits 510 included in the plurality of drive circuits 52 are provided on the surface 816 of the wiring substrate 810. Therefore, the possibility that heat generated in the amplification circuit 530 and heat generated in the amplification control circuit 510 affect each other is further reduced, and the possibility that the temperature of the drive circuit 52 rises is further reduced. Therefore, the possibility that the operational stability of each of the plurality of drive circuits 52 is lowered is reduced, and the possibility that the waveform accuracy of the drive signal COM output by the plurality of drive circuits 52 and the head drive module 10 including the plurality of drive circuits 52 is lowered is reduced.

Furthermore, among the heat sinks 710 and 720 that promote the heat dissipation of the amplification circuit 530, the heat sink 720 that promotes the heat dissipation of the amplification circuit 530 from the surface 816 side of the wiring substrate 810 and the amplification control circuit 510 are thermally coupled to each other, so that the dissipation efficiency of heat of the amplification control circuit 510 is also improved. Therefore, in addition to the transistors 531 and 532, the possibility that the temperature of the amplification control circuit 510 becomes high is also reduced. As a result, the possibility that the operational stability of the drive circuit 52 including the amplification circuit 530 and the amplification control circuit 510 is lowered is further reduced, and the possibility that the waveform accuracy of the drive signal COM output by the drive circuit 52 and the head drive module 10 including the drive circuit 52 is lowered is further reduced.

### 6. Modification Example

Here, in the liquid ejection apparatus 1 of the present embodiment described above, it is described that the heat sink 710 includes the cooling fan 713 and cooling of the drive circuit substrate 800 is promoted by the airflow sent by the cooling fan 713, but the present disclosure is not limited thereto.

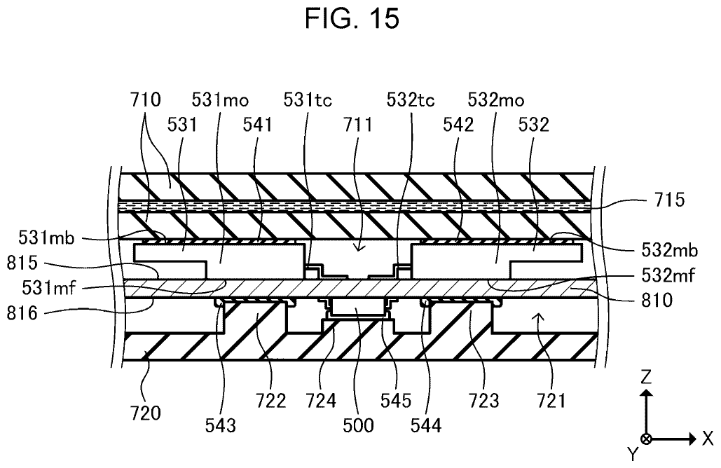

FIG. 15 is a view illustrating an example of a cross-section of the head drive module 10 according to a modification example. As illustrated in FIG. 15, the heat sink 710 may have a water cooling mechanism 715 that promotes cooling of the drive circuit substrate 800. The cooling water circulates in the water cooling mechanism 715 by power of a pump (not illustrated) or the like. As a result, the dissipation property of heat in the heat sink 710 is further improved, and the dissipation efficiency of heat of the transistors 531 and 532 in which the dissipation of heat is promoted by the heat sink 710 is improved.

In addition, the heat sinks 710 and 720 may be subjected to insulating coating, for example, with an epoxy resin or the like. Accordingly, in the heat sinks 710 and 720, the option for materials that can be used as the heat conductive members 541 provided between the transistor 531 and the heat sink 710, the heat conductive members 542 provided between the transistor 532 and the heat sink 710, the heat conductive members 543 and 544 provided between the wiring substrate 810 and the heat sink 720, and the heat conductive member 545 provided between the integrated circuit 500 and the heat sink 720 can be increased. In addition, the heat sinks 710 and 720 can directly promote dissipation of heat generated in the drive circuit 52 without using the heat conductive members 541 to 545. Therefore, the dissipation efficiency of heat generated in the drive circuit 52 by the heat sinks 710 and 720 is further improved. The heat sinks 710 and 720 may have an insulation performance, and may be made of insulating ceramic or the like instead of an insulating coat made of an epoxy resin or the like.

Hitherto, the embodiments and the modification examples are described. However, the present disclosure is not limited to the embodiments, and can be implemented in various aspects within the scope not departing from the concept of the present disclosure. For example, the above-described embodiments can also be appropriately combined with each other.

The present disclosure includes substantially the same configurations (for example, configurations having the same functions, methods, and results, or configurations having the same objects and effects) as the configurations described in the embodiments. Further, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. Further, the present disclosure includes configurations in which a known technology is added to the configurations described in the embodiments.

The following contents are derived from the above-described embodiments.

According to an aspect of the present disclosure, there is provided a capacitive load drive circuit including: a base drive signal output circuit to which a digital signal is input and which outputs a base drive signal; an amplification circuit that amplifies the base drive signal and outputs a drive signal for driving a capacitive load; a wiring substrate that has a first substrate surface and a second substrate surface located to face each other, and is provided with the base drive signal output circuit and the amplification circuit; and a first heat dissipation member and a second heat dissipation member that promote heat dissipation of the amplification circuit, in which the amplification circuit outputs the drive signal by driving of a first transistor and a second transistor, the first transistor has a first surface and a second surface located to face each other, the second transistor has a third surface and a fourth surface located to face each other, a heat dissipation property of the first heat dissipation member is higher than a heat dissipation property of the second heat dissipation member, the first surface and the third surface are thermally coupled to the first heat dissipation member, the second surface and the fourth surface are thermally coupled to the first substrate surface, and the second substrate surface is thermally coupled to the second heat dissipation member.

According to the capacitive load drive circuit, the first transistor included in the amplification circuit has the first surface and the second surface located to face each other, the second transistor included in the amplification circuit has the third surface and the fourth surface located to face each other, the first surface and the third surface are thermally coupled to the first heat dissipation member, the second surface and the fourth surface are thermally coupled to the first substrate surface, and the second substrate surface is thermally coupled to the second heat dissipation member. Therefore, dissipation of heat from both the first surface and the second surface is promoted in the first transistor, and dissipation of heat from both the third surface and the fourth surface is promoted in the second transistor. Therefore, heat generated in the amplification circuit including the first transistor and the second transistor is efficiently dissipated. Therefore, the concern that the first transistor and the second transistor become a high temperature is reduced, and the concern that the stability of the capacitive load drive circuit including the first transistor and the second transistor is lowered is reduced. Therefore, the possibility that the waveform accuracy of the drive signal output by the capacitive load drive circuit is lowered is reduced.

Further, according to the capacitive load drive circuit, the heat dissipation property of the first heat dissipation member that promotes dissipation of heat from the first surface of the first transistor and the third surface of the second transistor is set to be higher than the heat dissipation property of the second heat dissipation member that promotes dissipation of heat from the second surface of the first transistor and the fourth surface of the second transistor via the wiring substrate. Therefore, heat generated in the amplification circuit including the first transistor and the second transistor can be more efficiently dissipated without via the wiring substrate. Therefore, the concern that the first transistor and the second transistor become a high temperature is further reduced, and the concern that the stability of the capacitive load drive circuit including the first transistor and the second transistor is lowered is further reduced. Therefore, the possibility that the waveform accuracy of the drive signal output by the capacitive load drive circuit is lowered is further reduced.

In the capacitive load drive circuit according to the aspect, the first heat dissipation member may include a water cooling mechanism.

According to the capacitive load drive circuit, since the first heat dissipation member includes the water cooling mechanism, the heat dissipation property of the first heat dissipation member is further raised, and heat generated in the amplification circuit including the first transistor and the second transistor can be more efficiently dissipated.

In the capacitive load drive circuit according to the aspect, the first heat dissipation member may include an air cooling mechanism.

According to the capacitive load drive circuit, since the first heat dissipation member includes the air cooling mechanism, the heat dissipation property of the first heat dissipation member is further raised, and heat generated in the amplification circuit including the first transistor and the second transistor can be more efficiently dissipated.

In the capacitive load drive circuit according to the aspect, the wiring substrate may be accommodated in an accommodation portion configured by the first heat dissipation member and the second heat dissipation member.

According to the capacitive load drive circuit, heat of the amplification circuit including the first transistor and the second transistor can be efficiently dissipated by the first heat dissipation member and the second heat dissipation member, and the possibility that an ink mist or the like adheres to the amplification circuit including the first transistor and the second transistor can be reduced.

In the capacitive load drive circuit according to the aspect, an area of the first surface may be larger than an area of the second surface, and an area of the third surface may be larger than an area of the fourth surface.

According to the capacitive load drive circuit, the first heat dissipation member having a high heat dissipation property promotes heat dissipation of the first transistor and the second transistor from the first surface and the third surface having a large area, and thus heat generated in the amplification circuit including the first transistor and the second transistor can be more efficiently dissipated.

In the capacitive load drive circuit according to the aspect, the first transistor may include a first semiconductor chip, the second transistor may include a second semiconductor chip, thermal resistance between the first semiconductor chip and the first surface may be smaller than thermal resistance between the first semiconductor chip and the second surface, and thermal resistance between the second semiconductor chip and the third surface may be smaller than thermal resistance between the second semiconductor chip and the fourth surface.

According to the capacitive load drive circuit, the first heat dissipation member having a high heat dissipation property promotes heat dissipation of the first transistor and the second transistor from the first surface having small thermal resistance with the first semiconductor chip and the third surface having small thermal resistance with the second semiconductor chip, and thus heat of the first semiconductor chip and the second semiconductor chip which are heat sources can be efficiently dissipated. Therefore, heat generated in the amplification circuit including the first transistor and the second transistor is more efficiently dissipated.

In the capacitive load drive circuit according to the aspect, the first heat dissipation member may be subjected to insulating coating.

According to the capacitive load drive circuit, thermal resistance between the first heat dissipation member, the first transistor, and the second transistor can be reduced, and heat generated in the amplification circuit including the first transistor and the second transistor can be efficiently dissipated.

In the capacitive load drive circuit according to the aspect, the first surface and the first heat dissipation member may be coupled via a first heat conductive member having an insulation property, the third surface and the first heat dissipation member may be coupled via a second heat conductive member having an insulation property, and the second substrate surface and the second heat dissipation member may be coupled via a third heat conductive member having an insulation property.

According to the capacitive load drive circuit, thermal resistance between the first heat dissipation member, and the first transistor and the second transistor can be reduced, and the insulation performance between the first heat dissipation member, and the first transistor and the second transistor can be raised. Therefore, heat generated in the amplification circuit including the first transistor and the second transistor can be dissipated more efficiently, and the waveform accuracy of the output drive signal can be raised.

In the capacitive load drive circuit according to the aspect, the first transistor and the second transistor may be bipolar transistors, and the amplification circuit may be a class AB amplification circuit.

In the capacitive load drive circuit according to the aspect, the first transistor and the second transistor may be bipolar transistors of an SIP type.

According to another aspect of the present disclosure, there is provided a liquid ejection apparatus including: an ejection head that ejects a liquid by driving of a capacitive load; and a capacitive load drive circuit that outputs a drive signal for driving the capacitive load, in which the capacitive load drive circuit includes a base drive signal output circuit to which a digital signal is input and which outputs a base drive signal, an amplification circuit that amplifies the base drive signal and outputs the drive signal for driving the capacitive load, a wiring substrate that has a first substrate surface and a second substrate surface located to face each other, and is provided with the base drive signal output circuit and the amplification circuit, and a first heat dissipation member and a second heat dissipation member that promote heat dissipation of the amplification circuit, the amplification circuit outputs the drive signal by driving of a first transistor and a second transistor, the first transistor has a first surface and a second surface located to face each other, the second transistor has a third surface and a fourth surface located to face each other, a heat dissipation property of the first heat dissipation member is higher than a heat dissipation property of the second heat dissipation member, the first surface and the third surface are thermally coupled to the first heat dissipation member, the second surface and the fourth surface are thermally coupled to the first substrate surface, and the second substrate surface is thermally coupled to the second heat dissipation member.

According to this liquid ejection apparatus, in the capacitive load drive circuit, the first transistor included in the amplification circuit has the first surface and the second surface located to face each other, the second transistor included in the amplification circuit has the third surface and the fourth surface located to face each other, the first surface and the third surface are thermally coupled to the first heat dissipation member, the second surface and the fourth surface are thermally coupled to the first substrate surface, and the second substrate surface is thermally coupled to the second heat dissipation member. Therefore, dissipation of heat from both the first surface and the second surface is promoted in the first transistor, and dissipation of heat from both the third surface and the fourth surface is promoted in the second transistor. Therefore, heat generated in the amplification circuit including the first transistor and the second transistor is efficiently dissipated. Therefore, the concern that the first transistor and the second transistor become a high temperature is reduced, and the concern that the stability of the capacitive load drive circuit including the first transistor and the second transistor is lowered is reduced. Therefore, the possibility that the waveform accuracy of the drive signal output by the capacitive load drive circuit is lowered is reduced.

In addition, according to the liquid ejection apparatus, in the capacitive load drive circuit, the heat dissipation property of the first heat dissipation member that promotes dissipation of heat from the first surface of the first transistor and the third surface of the second transistor is set to be higher than the heat dissipation property of the second heat dissipation member that promotes dissipation of heat from the second surface of the first transistor and the fourth surface of the second transistor via the wiring substrate. Therefore, heat generated in the amplification circuit including the first transistor and the second transistor can be more efficiently dissipated without via the wiring substrate. Therefore, the concern that the first transistor and the second transistor become a high temperature is further reduced, and the concern that the stability of the capacitive load drive circuit including the first transistor and the second transistor is lowered is further reduced. Therefore, the possibility that the waveform accuracy of the drive signal output by the capacitive load drive circuit is lowered is further reduced.

In the liquid ejection apparatus according to the aspect, the first heat dissipation member may include a water cooling mechanism.

According to this liquid ejection apparatus, since the first heat dissipation member includes the water cooling mechanism, the heat dissipation property of the first heat dissipation member is further raised, and heat generated in the amplification circuit including the first transistor and the second transistor can be more efficiently dissipated.

In the liquid ejection apparatus according to the aspect, the first heat dissipation member may include an air cooling mechanism.

According to this liquid ejection apparatus, since the first heat dissipation member includes the air cooling mechanism, the heat dissipation property of the first heat dissipation member is further raised, and heat generated in the amplification circuit including the first transistor and the second transistor can be more efficiently dissipated.

In the liquid ejection apparatus according to the aspect, the wiring substrate may be accommodated in an accommodation portion configured by the first heat dissipation member and the second heat dissipation member.

According to this liquid ejection apparatus, heat of the amplification circuit including the first transistor and the second transistor can be efficiently dissipated by the first heat dissipation member and the second heat dissipation member, and the possibility that an ink mist or the like adheres to the amplification circuit including the first transistor and the second transistor can be reduced.

In the liquid ejection apparatus according to the aspect, an area of the first surface may be larger than an area of the second surface, and an area of the third surface may be larger than an area of the fourth surface.

According to this liquid ejection apparatus, the first heat dissipation member having a high heat dissipation property promotes heat dissipation of the first transistor and the second transistor from the first surface and the third surface having a large area, and thus heat generated in the amplification circuit including the first transistor and the second transistor can be more efficiently dissipated.

In the liquid ejection apparatus according to the aspect, the first transistor may include a first semiconductor chip, the second transistor may include a second semiconductor chip, thermal resistance between the first semiconductor chip and the first surface may be smaller than thermal resistance between the first semiconductor chip and the second surface, and thermal resistance between the second semiconductor chip and the third surface may be smaller than thermal resistance between the second semiconductor chip and the fourth surface.

According to this liquid ejection apparatus, the first heat dissipation member having a high heat dissipation property promotes heat dissipation of the first transistor and the second transistor from the first surface having small thermal resistance with the first semiconductor chip and the third surface having small thermal resistance with the second semiconductor chip, and thus heat of the first semiconductor chip and the second semiconductor chip which are heat sources can be efficiently dissipated. Therefore, heat generated in the amplification circuit including the first transistor and the second transistor is more efficiently dissipated.

In the liquid ejection apparatus according to the aspect, the first heat dissipation member may be subjected to insulating coating.

According to this liquid ejection apparatus, the first heat dissipation member having a high heat dissipation property promotes heat dissipation of the first transistor and the second transistor from the first surface having small thermal resistance with the first semiconductor chip and the third surface having small thermal resistance with the second semiconductor chip, and thus heat of the first semiconductor chip and the second semiconductor chip which are heat sources can be efficiently dissipated. Therefore, heat generated in the amplification circuit including the first transistor and the second transistor is more efficiently dissipated.

In the liquid ejection apparatus according to the aspect, the first surface and the first heat dissipation member may be coupled via a first heat conductive member having an insulation property, the third surface and the first heat dissipation member may be coupled via a second heat conductive member having an insulation property, and the second substrate surface and the second heat dissipation member may be coupled via a third heat conductive member having an insulation property.

According to this liquid ejection apparatus, thermal resistance between the first heat dissipation member, and the first transistor and the second transistor can be reduced, and the insulation performance between the first heat dissipation member, and the first transistor and the second transistor can be raised. Therefore, heat generated in the amplification circuit including the first transistor and the second transistor can be dissipated more efficiently, and the waveform accuracy of the output drive signal can be raised.

In the liquid ejection apparatus according to the aspect, the first transistor and the second transistor may be bipolar transistors, and the amplification circuit may be a class AB amplification circuit.

In the liquid ejection apparatus according to the aspect, the first transistor and the second transistor may be bipolar transistors of an SIP type.

What is claimed is:

1. A capacitive load drive circuit comprising:
a base drive signal output circuit to which a digital signal is input and which outputs a base drive signal;
an amplification circuit that amplifies the base drive signal and outputs a drive signal for driving a capacitive load;
a wiring substrate that has a first substrate surface and a second substrate surface located to face each other, and is provided with the base drive signal output circuit and the amplification circuit; and
a first heat dissipation member and a second heat dissipation member that promote heat dissipation of the amplification circuit, wherein
the amplification circuit outputs the drive signal by driving of a first transistor and a second transistor,
the first transistor has a first surface and a second surface located to face each other,
the second transistor has a third surface and a fourth surface located to face each other,
a heat dissipation property of the first heat dissipation member is higher than a heat dissipation property of the second heat dissipation member,
the first surface and the third surface are thermally coupled to the first heat dissipation member,
the second surface and the fourth surface are thermally coupled to the first substrate surface, and
the second substrate surface is thermally coupled to the second heat dissipation member.

2. The capacitive load drive circuit according to claim 1, wherein
the first heat dissipation member includes a water cooling mechanism.

3. The capacitive load drive circuit according to claim 1, wherein
the first heat dissipation member includes an air cooling mechanism.

4. The capacitive load drive circuit according to claim 1, wherein
the wiring substrate is accommodated in an accommodation portion configured by the first heat dissipation member and the second heat dissipation member.

5. The capacitive load drive circuit according to claim 1, wherein
an area of the first surface is larger than an area of the second surface, and
an area of the third surface is larger than an area of the fourth surface.

6. The capacitive load drive circuit according to claim 1, wherein
the first transistor includes a first semiconductor chip,
the second transistor includes a second semiconductor chip,
thermal resistance between the first semiconductor chip and the first surface is smaller than thermal resistance between the first semiconductor chip and the second surface, and
thermal resistance between the second semiconductor chip and the third surface is smaller than thermal resistance between the second semiconductor chip and the fourth surface.

7. The capacitive load drive circuit according to claim 1, wherein
the first heat dissipation member is subjected to insulating coating.

8. The capacitive load drive circuit according to claim 1, wherein
the first surface and the first heat dissipation member are coupled via a first heat conductive member having an insulation property,
the third surface and the first heat dissipation member are coupled via a second heat conductive member having an insulation property, and
the second substrate surface and the second heat dissipation member are coupled via a third heat conductive member having an insulation property.

9. The capacitive load drive circuit according to claim 1, wherein
the first transistor and the second transistor are bipolar transistors, and
the amplification circuit is a class AB amplification circuit.

10. The capacitive load drive circuit according to claim 9, wherein
the first transistor and the second transistor are bipolar transistors of an SIP type.

11. A liquid ejection apparatus comprising:
an ejection head that ejects a liquid by driving of a capacitive load; and
a capacitive load drive circuit that outputs a drive signal for driving the capacitive load, wherein
the capacitive load drive circuit includes
a base drive signal output circuit to which a digital signal is input and which outputs a base drive signal,
an amplification circuit that amplifies the base drive signal and outputs the drive signal for driving the capacitive load,
a wiring substrate that has a first substrate surface and a second substrate surface located to face each other, and is provided with the base drive signal output circuit and the amplification circuit, and
a first heat dissipation member and a second heat dissipation member that promote heat dissipation of the amplification circuit,
the amplification circuit outputs the drive signal by driving of a first transistor and a second transistor,
the first transistor has a first surface and a second surface located to face each other,
the second transistor has a third surface and a fourth surface located to face each other,
a heat dissipation property of the first heat dissipation member is higher than a heat dissipation property of the second heat dissipation member,
the first surface and the third surface are thermally coupled to the first heat dissipation member,
the second surface and the fourth surface are thermally coupled to the first substrate surface, and
the second substrate surface is thermally coupled to the second heat dissipation member.

12. The liquid ejection apparatus according to claim 11, wherein
the first heat dissipation member includes a water cooling mechanism.

13. The liquid ejection apparatus according to claim 11, wherein
the first heat dissipation member includes an air cooling mechanism.

14. The liquid ejection apparatus according to claim 11, wherein
the wiring substrate is accommodated in an accommodation portion configured by the first heat dissipation member and the second heat dissipation member.

15. The liquid ejection apparatus according to claim 11, wherein
an area of the first surface is larger than an area of the second surface, and
an area of the third surface is larger than an area of the fourth surface.

16. The liquid ejection apparatus according to claim 11, wherein
the first transistor includes a first semiconductor chip,
the second transistor includes a second semiconductor chip,
thermal resistance between the first semiconductor chip and the first surface is smaller than thermal resistance between the first semiconductor chip and the second surface, and
thermal resistance between the second semiconductor chip and the third surface is smaller than thermal resistance between the second semiconductor chip and the fourth surface.

17. The liquid ejection apparatus according to claim 11, wherein
the first heat dissipation member is subjected to insulating coating.

18. The liquid ejection apparatus according to claim 11, wherein
the first surface and the first heat dissipation member are coupled via a first heat conductive member having an insulation property,
the third surface and the first heat dissipation member are coupled via a second heat conductive member having an insulation property, and
the second substrate surface and the second heat dissipation member are coupled via a third heat conductive member having an insulation property.

19. The liquid ejection apparatus according to claim 11, wherein
the first transistor and the second transistor are bipolar transistors, and
the amplification circuit is a class AB amplification circuit.

20. The liquid ejection apparatus according to claim 19, wherein
the first transistor and the second transistor are bipolar transistors of an SIP type.
